(19) United States
(12) Patent Application Publication
(10) Pub. No.: US 2016/0041118 A1
(43) Pub. Date: Feb. 11, 2016

(54) ENZYME TRIGGERED REDOX ALTERING CHEMICAL ELIMINATION (E-TRACE) ASSAY WITH MULTIPLEXING CAPABILITIES

(71) Applicant: OHMX Corporation, Evanston, IL (US)

(72) Inventor: Yijia Paul Bao, Deer Park, IL (US)

(21) Appl. No.: 14/824,045

(22) Filed: Aug. 11, 2015

Related U.S. Application Data
(60) Provisional application No. 62/036,078, filed on Aug. 11, 2014.

(51) Int. Cl. G01N 27/327

(52) U.S. Cl. CPC G01N 27/3276

(57) ABSTRACT

Methods for the electrochemical detection of target analytes using a porous substrate and related systems are provided. In some embodiments, an electrochemical assay comprises determining the presence, absence, and/or concentration of one or more target analyte based on the electrical potential of an electroactive moiety (EAM) comprising a self-immolative moiety (SIM). In some embodiments, at least a portion of the electrochemical assay may occur within, on, and/or near a porous substrate. In some such embodiments, one or more component of the electrochemical assay (e.g., capture ligand, enzyme) may be immobilized within and/or on the porous substrate. In some embodiments, the immobilization of one or more assay components within and/or on the porous substrate may allow for the detection of multiple target analytes in a single sample as well as enhance assay performance.

From equation 2 (Eq. 2) (μ_{Fe}_{^{3−}}⁰−μ_{Fe}_{²⁺}⁰)/F is set equal to E_{Fe}_{³⁺}_{/Fe}_{²⁺}⁰, which is the standard electrode potential, when the pH and ln p_{H}_{₂} are equal to zero.

E_{Fe}_{³⁺}_{/Fe}_{²⁺}⁰=(μ_{Fe}_{^{3−}}⁰−μ_{Fe}_{²⁺}⁰)/F+(RT/F)pH+(RT/F)ln(p(H₂)a_{Fe}_{³⁺}/p⁰a_{Fe}_{²⁺}) (Eq. 2)

In the subscript of the symbol for the electrode potential, E, the symbols for the oxidized and reduced components of the oxidation-reduction system are indicated. With more complex reactions it is particularly recommended to write the whole reaction that takes place in the right-hand half of the cell after symbol E (the ‘half-cell’ reaction); thus, in the present case

E_{Fe}_{³⁺}_{/Fe}_{²⁺}⁰≡E(Fe³⁺+e=Fe²⁺)

Quantity E_{Fe}_{³⁺}_{/Fe}_{²⁺}⁰ is termed the standard electrode potential. It characterizes the oxidizing or reducing ability of the component of oxidation-reduction systems. With more positive standard electrode potentials, the oxidized form of the system is a stronger oxidant and the reduced form is a weaker reductant. Similarly, with a more negative standard potential, the reduced component of the oxidation-reduction system is a stronger reductant and the oxidized form a weaker oxidant.

The standard electrode E⁰, in its standard usage in the Nernst equation, is described as:

$$E = {E}^{0} + \frac{2.3 RT}{nF} log \frac{{C}_{0} ( 0 , t )}{{C}_{R} ( 0 , t )} \qquad ( Eq . 3 )$$

where E⁰ is the standard potential for the redox reaction, R is the universal gas constant (8.314 JK⁻¹mol⁻¹), T is the Kelvin temperature, n is the number of electrons transferred in the reaction, and F is the Faraday constant (96,487 coulombs). On the negative side of E⁰, the oxidized form thus tends to be reduced, and the forward reaction (i.e., reduction) is more favorable. The current resulting from a change in oxidation state of the electroactive species is termed the faradaic current.

It is highly desirable to be able to test for multiple target analytes using a single sample. It is even more desirable to be able to test for multiple target analytes without the need to divide the sample into multiple parts and perform separate sample preparations and assay protocols for each portion. However, some conventional electrochemical assays do not allow for such multiplexing capabilities. There is a need for electrochemical assays with multiplexing capabilities.

### SUMMARY OF THE INVENTION

Methods for utilizing solid supports to enhance assay performance and increase multiplexing capabilities and related compositions, cartridges, and systems are generally described. The subject matter of the present invention involves, in some cases, interrelated products, alternative solutions to a particular problem, and/or a plurality of different uses of one or more systems and/or articles.

In one set of embodiments, methods are provided. In one embodiment, a method for detecting a target analyte within a test sample comprises adding a sample to a compartment comprising a porous substrate, wherein the porous substrate comprises an immobilized target specific detection molecule and is in contact with a solid support comprising an electrode comprising an electroactive moiety (EAM) comprising a transition metal complex and a self-immolative moiety (SIM), wherein the EAM has a first E⁰ when the SIM is present, and a second E⁰ when the SIM is absent. The method also comprises exposing the porous substrates to a set of conditions that generate a mediator in the presence of a target analyte, wherein the mediator interacts with the EAM and the SIM is removed, such that the EAM has a second E⁰ and measuring the change in E⁰ of solid support as an indicator of the presence of the target analyte within the sample.

In another embodiment, a method for detecting multiple target analytes within a test sample comprises adding a sample to a compartment comprising a first porous substrate and a second porous substrate in fluid communication, wherein i) the first porous substrate comprises an immobilized target specific detection molecule and the second porous substrate comprise a different immobilized target specific detection molecule, ii) the first porous substrate is in contact with a first solid support and the second porous substrates is in contact with a second solid support, and iii) the first solid support and the second solid support comprise an electrode. The electrode comprises an electroactive moiety (EAM) comprising a transition metal complex and a self-immolative moiety (SIM), wherein the EAM has a first E⁰ when the SIM is present, and a second E⁰ when the SIM is absent and wherein the mediator interacts with the EAM and the SIM is removed, such that the EAM has a second E⁰. The method also comprises exposing the first porous substrate and the second porous substrate to a set of conditions that results in the generation of a mediator in the first solid support in the presence of a first target analyte, and measuring the change in E⁰ of the first solid support and the second solid support as an indicator of the presence of the first target analyte and the second target analyte within the sample.

In one embodiment, a method for detecting a target analyte in a test sample comprises providing a solid support comprising an electrode comprising a self-assembled monolayer (SAM), a covalently attached electroactive active moiety (EAM) comprising a transition metal complex comprising a self-immolative moiety (SIM) and a peroxide sensitive moiety (PSM), wherein the EAM has a first E⁰ with the SIM attached and a second E⁰ with the SIM removed, and a porous substrate comprising a capture binding ligand that binds the analyte. The method also comprises contacting the target analyte(s) and the solid supports under conditions wherein the target analyte binds the capture binding ligand to form a first complex, contacting the first complex with a soluble capture ligand that binds the target analyte, adding substrate(s) of peroxide generating moiety to the second complex under conditions that peroxide is generated, and detecting a change in E⁰ as an indication of the presence of the target analyte. In such methods, the soluble capture ligand comprises a peroxide generating moiety to form a second complex and the peroxide reacts with the peroxide sensitive moiety of the EAM and the self-immolative moiety is removed such that the EAM has a second E⁰.

In one set of embodiments, compositions are provided. In one embodiment, a composition comprises a first porous substrate comprising an immobilized target specific detection molecule, a second porous substrate comprise a different immobilized target specific detection molecule, a first solid support in direct contact with the first porous substrate, and a second solid support in direct contact with the second porous substrate. The first porous substrate can be in fluid communication with the second porous substrate if solution is added and the first solid support and the second solid support comprise an electrode comprising an electroactive moiety (EAM) comprising a transition metal complex, a self-immolative moiety (SIM), and a peroxide sensitive moiety (PSM), wherein the EAM has a first E⁰ when the SIM and PSM are present, and a second E⁰ when the SIM and PSM are absent.

In one set of embodiments, assay cartridges are provided. In one embodiment, an assay cartridge comprises a top layer comprising at least one chamber comprising an assay reagent, a middle layer comprising a porous substrate comprising an immobilized target specific detection molecule, and a bottom layer comprising a waste chamber and an electrode chamber. The top, middle, and bottom layers have a common central axis and are capable of rotating around the common central axis.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### DESCRIPTION OF THE FIGURES

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows a schematic of a porous substrate in contact with a modified electrode, according to certain embodiments.

FIG. 2 shows a schematic of a single compartment containing three porous substrates, wherein each porous substrate is in contact with a different electrode and has a different assay component immobilized therein, according to certain embodiments.

FIG. 3A shows a schematic of a step of a multiplexing methods, according to certain embodiments.

FIG. 3B shows a schematic of a step of a multiplexing methods, according to certain embodiments.

FIG. 3C shows a schematic of a step of a multiplexing methods, according to certain embodiments.

FIG. 3D shows a schematic of a step of a multiplexing methods, according to certain embodiments.

FIG. 3E shows a schematic of a step of a multiplexing methods, according to certain embodiments.

FIG. 3F shows a schematic of a step of a multiplexing methods, according to certain embodiments.

FIG. 3G shows a schematic of a step of a multiplexing methods, according to certain embodiments.

FIG. 3H shows a schematic of a step of a multiplexing methods, according to certain embodiments.

FIG. 4 shows a schematic of a device for performing certain inventive methods described herein, according to one set of embodiments.

FIG. 5 shows a schematic of a multi-level rotating cartridge for performing certain inventive methods described herein, according to certain embodiments.

FIG. 6 shows a picture of an experimental set-up for an assay utilizing a porous substrate, according to one set of embodiments.

FIG. 7 shows a dose response for a hemoglobin A1c assay using certain inventive methods described herein, according to certain embodiments.

FIG. 8A shows voltammograms for ATP, NADH, HSP70, and an untreated electrode from an array of electrodes in a multiplexing assay, according to certain embodiments.

FIG. 8B shows a voltammogram for one of the target analytes present within a multiplexing assay, according to certain embodiments.

FIG. 8C shows a dose response graph for a target analyte generated using a multiplex assay, according to certain embodiments.

FIG. 9A shows voltammograms for glucose, cholesterol, hemoglobin A1c (A1c), and an untreated electrode from an array of electrodes in a multiplexing assay, according to certain embodiments.

FIG. 9B shows a dose response produced for hemoglobin A1c, according to certain embodiments.

FIG. 9C shows a dose response produced for glucose, according to certain embodiments.

FIG. 9D shows a dose response produced for cholesterol, according to certain embodiments.

FIG. 10A shows a schematic of a step of performing an assay using a rotating cartridge, according to certain embodiments.

FIG. 10B shows a schematic of a step of performing an assay using a rotating cartridge, according to certain embodiments.

FIG. 10C shows a schematic of a step of performing an assay using a rotating cartridge, according to certain embodiments.

FIG. 10D shows a schematic of a step of performing an assay using a rotating cartridge, according to certain embodiments.

FIG. 10E shows a schematic of a step of performing an assay using a rotating cartridge, according to certain embodiments.

FIG. 10F shows a schematic of a step of performing an assay using a rotating cartridge, according to certain embodiments.

FIG. 10G shows a schematic of a step of performing an assay using a rotating cartridge, according to certain embodiments.

FIG. 10H shows a schematic of a step of performing an assay using a rotating cartridge, according to certain embodiments.

FIG. 10I shows a schematic of a step of performing an assay using a rotating cartridge, according to certain embodiments.

FIG. 10J shows a schematic of a step of performing an assay using a rotating cartridge, according to certain embodiments.

FIG. 10K shows a schematic of a step of performing an assay using a rotating cartridge, according to certain embodiments.

FIG. 10L shows a schematic of a step of performing an assay using a rotating cartridge, according to certain embodiments.

FIG. 10M shows a schematic of a step of performing an assay using a rotating cartridge, according to certain embodiments.

FIG. 10N shows a schematic of a step of performing an assay using a rotating cartridge, according to certain embodiments.

FIG. 10O shows a schematic of a step of performing an assay using a rotating cartridge, according to certain embodiments.

FIG. 10P shows a schematic of a step of performing an assay using a rotating cartridge, according to certain embodiments.

FIG. 10Q shows a schematic of a step of performing an assay using a rotating cartridge, according to certain embodiments.

FIG. 10R shows a schematic of a step of performing an assay using a rotating cartridge, according to certain embodiments.

FIG. 10S shows a schematic of a step of performing an assay using a rotating cartridge, according to certain embodiments.

FIG. 10T shows a schematic of a step of performing an assay using a rotating cartridge, according to certain embodiments.

FIG. 10U shows a schematic of a step of performing an assay using a rotating cartridge, according to certain embodiments.

FIG. 10V shows a schematic of a step of performing an assay using a rotating cartridge, according to certain embodiments.

### DETAILED DESCRIPTION OF THE INVENTION

Methods for the electrochemical detection of target analytes using a porous substrate and related systems are provided. In some embodiments, an electrochemical assay comprises determining the presence, absence, and/or concentration of one or more target analytes based on the electrical potential of an electroactive moiety (EAM). The electroactive moiety may comprise a self-immolative moiety (SIM). In embodiments in which the target analyte is present, the method may comprise one or more biological binding events (e.g., between complementary pairs of biological molecules) that cause, at least in part, the production of a mediator (e.g., chemical species). The mediator may interact with the self-immolative moiety, such that the electrical potential of the electroactive moiety is detectably altered. In some embodiments, at least a portion of the electrochemical assay may occur within, on, and/or near a porous substrate. For instance, one or more of the biological binding events and/or the production of the mediator (e.g., chemical species) may occur within and/or on the porous substrate. In some such embodiments, one or more components of the electrochemical assay (e.g., capture ligand, enzyme) may be immobilized within and/or on the porous substrate. In some embodiments, the immobilization of one or more assay components within and/or on the porous substrate may allow for the detection of multiple target analytes in a single, undivided sample as well as enhance assay performance.

It has been discovered, within the context of certain inventive embodiments, that certain electrochemical assays may be performed within and/or on a porous substrate with minimal and/or no negative impact on assay performance. Surprisingly, certain porous substrates allow for suitable diffusion of the mediator to allow for sensitive and specific detection of a target analyte. It has unexpectedly been discovered that the porous substrate can significantly hinder diffusion of some assay components and/or mediators outside of the porous substrate and may serve to isolate certain assay components and/or liquids within the porous substrate. These barrier properties may allow multiple porous substrates to be in fluid communication (e.g, liquid communication, gaseous communication) with one another (e.g., in a single compartment) during one or more assay step with little or no cross-contamination between the components in each porous substrates. Moreover, the barrier properties of the porous substrates may also facilitate isolation of multiple porous substrates contained within a single compartment (e.g., when hydrophilic interactions facilitate the retention of sample and assay components within said porous substrates, while the hydrophobic spaces between multiple porous substrates remain dry and clear of solution). That is, in some embodiments, multiple target analytes may be assayed in a single, undivided sample using porous substrates designed for different target analytes. In general, the detection of a target analyte may be based on a change in the electrical potential of the EAM due to at least one chemical reaction between the EAM and a mediator, which is produced when the target analyte is present. For example, an electroactive moiety (EAM) comprising a self-immolative moiety (SIM) may have a first E⁰ when the SIM is present, and a second E⁰ when the SIM is absent. The SIM may be removed through an irreversible chemical elimination reaction, causing the E⁰ of the EAM to change from the first E⁰ to the second E⁰. The chemical elimination reaction may be triggered by the presence of the mediator. For instance, in embodiments in which the EAM also comprises a peroxide sensitive moiety (PSM), the mediator is hydrogen peroxide, which initiates the chemical elimination by interacting with the PSM attached to the SIM.

In one set of embodiments, to determine whether a target analyte is present in the sample, an electrochemical assay method may comprise exposing the sample to a capture binding ligand, which binds the target analyte, and a second soluble binding ligand, comprising a peroxide generating moiety or a part of a peroxide generating system, that binds an alternative epitope of the target analyte. The capture binding ligand and second soluble binding ligand may create a “sandwich assay” format with the target analyte. The sandwich may then be contacted with any remaining necessary substrates for the peroxide generating moiety or components of the peroxide generating system to generate hydrogen peroxide. In some embodiments, the electrochemical assay may be performed in the presence of the self-assembled monolayer (SAM), such that the hydrogen peroxide may diffuse to the SAM and triggers a chemical elimination reaction (“self-immolative” reaction) in the EAMs. This irreversible elimination reaction changes the E⁰ of the EAM to signal the presence of the target. In other embodiments, the electrochemical assay may not be performed in the presence of the self-assembled monolayer (SAM).

As described herein, at least a portion of the electrochemical assay method may be performed in a porous substrate comprising one or more immobilized assay components (e.g., target specific detection component). In some such embodiments, the electrochemical assay method may comprise exposing the porous substrates to a sample and non-immobilized assay components. For instance, in embodiments in which the porous substrate comprises an immobilized capture ligand, the electrochemical assay may comprise exposing the porous substrate comprising the immobilized capture ligand to a sample. The sample may be exposed to the porous substrate for a suitable period of time to allow for sufficient capture of the target analyte, if present. At least a portion of the sample may be optionally removed and/or the porous substrate comprising the immobilized capture ligand and bound target ligand may be washed. In some embodiments, the porous substrate comprising the immobilized capture ligand bound to the target analyte may be exposed to a soluble binding ligand that comprises a peroxide generating moiety or a part of a peroxide generating system, that binds an alternative epitope of the target analyte. The soluble binding ligand may be exposed to the porous substrate for a suitable period of time to allow for sufficient capture of the soluble binding ligand, if the target is present. At least a portion of the soluble binding ligand may be optionally removed and/or the porous substrate comprising the immobilized target ligand in sandwich format may be washed. In some embodiments, the porous substrate may be exposed to any remaining substrates necessary to generate hydrogen peroxide. In some embodiments, the porous substrate may be in contact with a solid support comprising one or more electrodes prior to, during, and/or after one or more of the exposure steps and/or generation of the hydrogen peroxide. In some such embodiments, in which the porous substrate is in contact with the solid support, the hydrogen peroxide may diffuse to the self-assembled monolayer on the solid support and trigger a chemical elimination reaction in the EAMs of the electrodes.

In general, any suitable assay component may be immobilized on the porous substrate. In some embodiments, a target specific detection component may be immobilized on the porous substrate. As used herein, the term “target specific detection component” or other grammatical equivalents herein has its ordinary meaning in the art and may refer to a component that interacts with a target in such a way as to allow for the generation of a signal indicating the presence of a target. Non-limiting examples of target specific detection components include capture ligands, components that react with the target (e.g., enzymes, enzymatic substrates), components that are used as part of a standard sandwich format assay, and components of the target-dependent peroxide generating system. In some embodiments, the target specific detection component may be directly or indirectly immobilized within and/or on the porous substrate. For instance, the target specific detection component may associated with and/or immobilized on particles (e.g., magnetic beads) immobilized within and/or on a porous substrate. In some embodiments, target specific detection components are used to modify the porous substrates to make the porous substrate specific for a particular target of interest. As non-limiting examples of target/target specific detection components, protein/antibody, enzyme/substrate, substrate/enzyme, protein/aptamer, and nucleic acid sequence/complementary nucleic acid sequence may be used.

In some embodiments, when the target analyte is a substrate for a peroxide generating enzyme, the porous substrate may comprise a complementary immobilized peroxide generating enzyme such that when the porous substrate is contacted with a sample containing the target analyte peroxide is produced. In some embodiments, when the target analyte is a part of a peroxide generating system, the porous substrate may comprise one or more immobilized remaining components of the peroxide generating system, such that when the porous substrate is contacted with a sample containing the target analyte and the remaining components of the peroxide generating system, peroxide is produced.

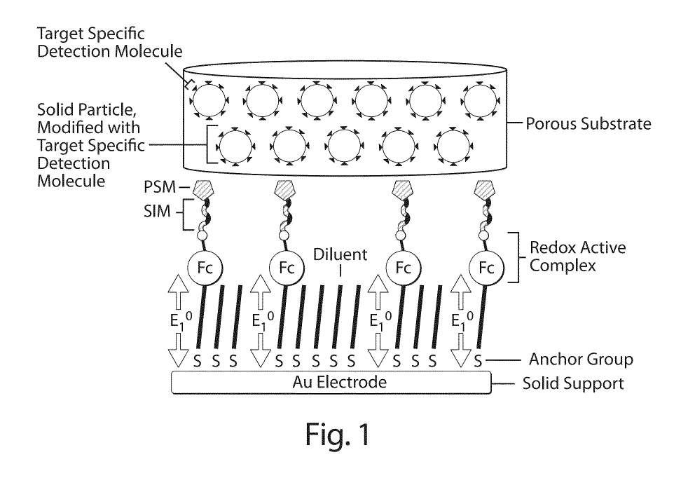

A non-limiting example of a porous substrate comprising an immobilized assay component (e.g., target specific detection component) in contact with a solid support comprising one or more electrode is shown in FIG. 1. In some embodiments, an assay component (e.g., target specific detection component) may be physically immobilized on and/or within the solid support. For instance, an assay component with at least one cross-sectional dimension greater than the average pore size of the porous solid support may be immobilized on and/or within a porous support. In some instances, an assay component may be immobilized on and/or within the solid support via a biological and/or chemical interaction. For instance, in embodiments in which the assay component is a biological molecule, a biological binding event between the assay component and a binding partner that is immobilized on and/or within the substrate may cause the assay component to be immobilized. In some instances, the assay component (e.g., target specific detection component) may be immobilized on and/or within the porous substrate using a non-covalent and/or covalent bond. For instance, in some embodiments, the assay component may be immobilized on or within the porous substrate via van der Waals interactions.

In certain embodiments, as shown in FIG. 1, an assay component may be based on one or more physical, chemical, and/or biological interaction with the solid support and/or a component associated with the porous substrate. For instance, particle (e.g., magnetic beads) having a target specific detection component (e.g., target specific capture antibody and/or an enzyme) attached thereto may be immobilized within and/or on a porous substrate (e.g., membrane) as illustrated in FIG. 1. A cross-sectional dimension of the particles (e.g., magnetic beads) may serve to physically immobilize the particles within the solid support. The target specific detection component (e.g., target specific capture antibody and/or an enzyme) may be attached to particle (e.g., magnetic bead) such that immobilization of the particles results in immobilization of the target specific detection component (e.g., target specific capture antibody and/or an enzyme). In some embodiments, the porous substrate may be in contact, directly or indirectly, with the solid support. In some instances, the porous substrate may be in direct contact with the solid support as illustrated in FIG. 1.

In some embodiments, the utilization of a porous substrate may allow for multiplexing. In some such embodiments, multiple porous substrates can be used to immobilize components needed to detect varying targets, allowing the user to perform a single sample preparation and assay protocol to detect multiple target analytes in the sample. In some embodiments, multiple porous substrates are arranged in an array format, wherein each individual porous substrate of the array has been independently modified so as to capture, react with, and/or detect a separate, specific target analyte, if present. That is, an array format can be used to detect multiple target analytes within the same sample when each solid support of the array is modified for a different target. In some embodiments, solid support arrays are used to allow multiplexing.

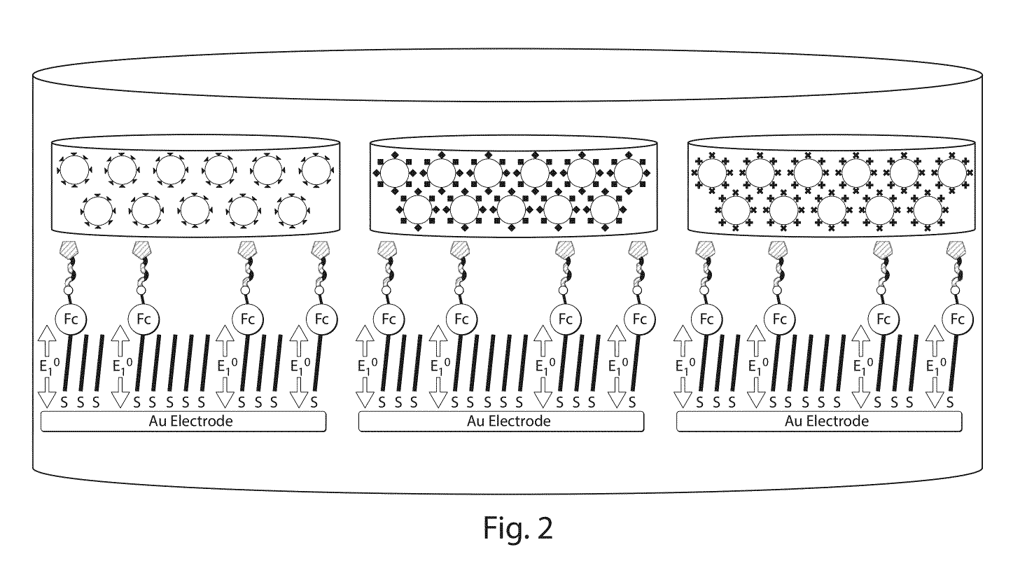

A non-limiting example of porous substrates arranged in an array format, wherein each individual porous substrate of the array has been independently modified so as to capture, react with, and/or detect a separate, specific target analyte, if present, is shown in FIG. 2. FIG. 2 shows a single compartment (e.g., well) comprising an array of porous substrates (e.g., membranes) with target binding ligands or target small molecule specific enzymes immobilized in each porous substrate, e.g., via physical immobilization of particles comprising a chemically (e.g., covalently, non-covalently) bound target binding ligands or target small molecule specific enzymes. In some embodiments, each porous substrate may comprise an immobilized target specific detection component for a different target of interest and may be in fluid communication with one another during certain assay steps. In certain embodiments, though two or more porous substrates (e.g., each) in the array may occupy the same compartment, the porous substrates may not be in liquid communication during certain assay steps (e.g., after removal of a solution). In some such embodiments, at least a portion of the (e.g., each) porous substrates may serve to retain liquid and/or assay components and isolate them from another porous substrates in the array.

A separate but adjacent array of solid supports comprising electrodes comprising SAMs comprising EAMs comprising a transition metal complex and PSM may be associated with the array of porous substrates as illustrated in FIG. 2. In some embodiments, at least a portion (e.g., each) of the porous substrates in the array is associated with a porous substrate in the adjacent array to form porous substrate-solid support pairs. In some embodiments, a porous substrate-solid support pair can be used to detect a specific target in a test sample independently of the other porous substrate-solid support pairs in the array. For example, referring to FIG. 2, each of the three porous substrates in the array may comprise an immobilized target specific detection component for a different target analyte and each target analyte may be detected independently with little or no chemical and/or electrical cross-contamination between the porous substrates and solid supports.

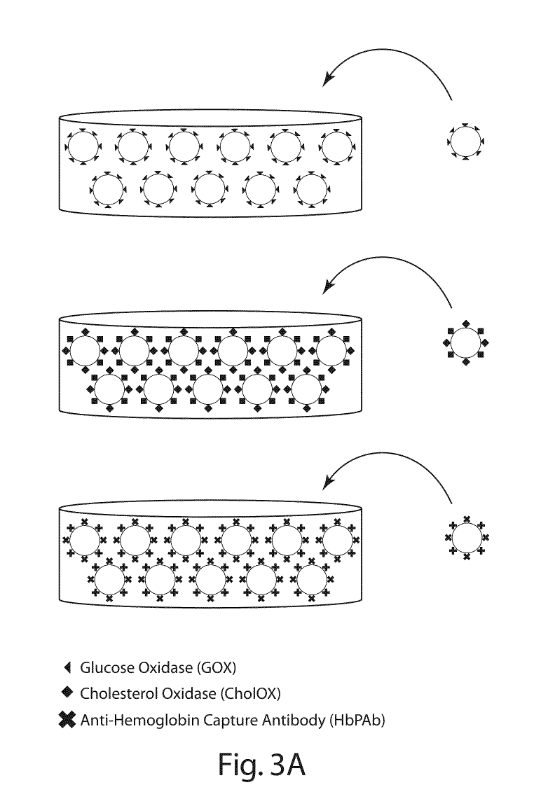

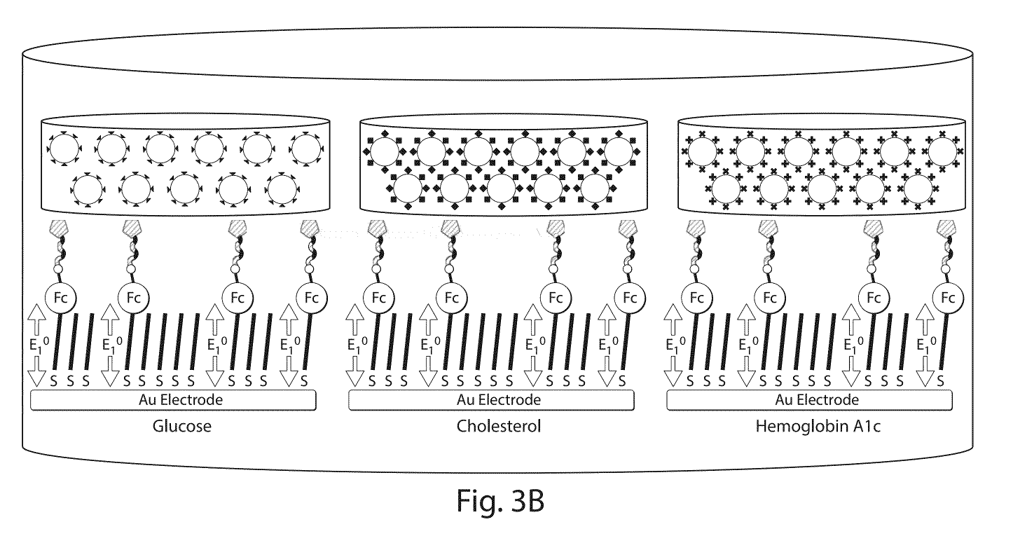

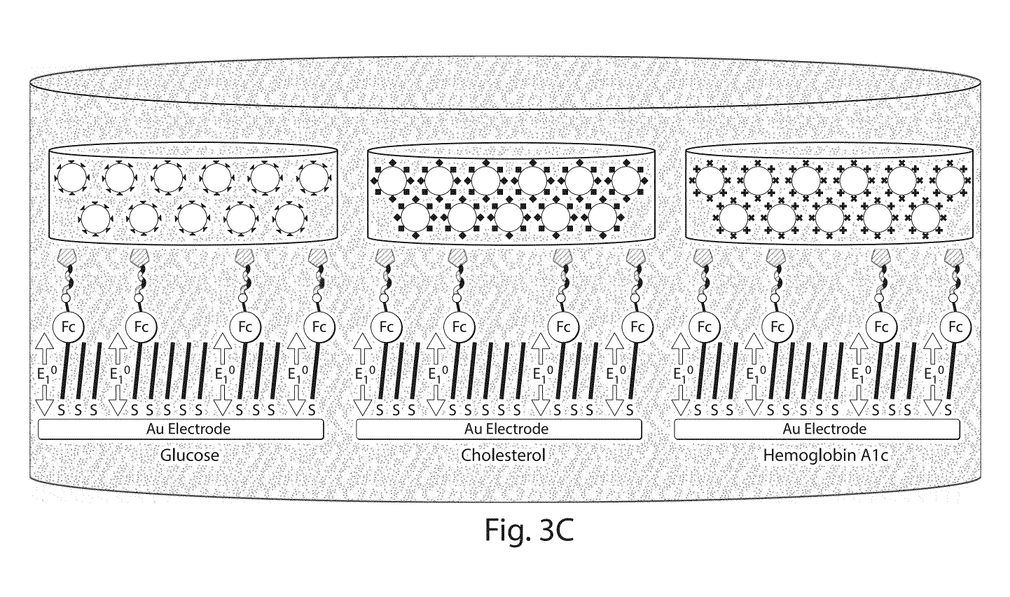

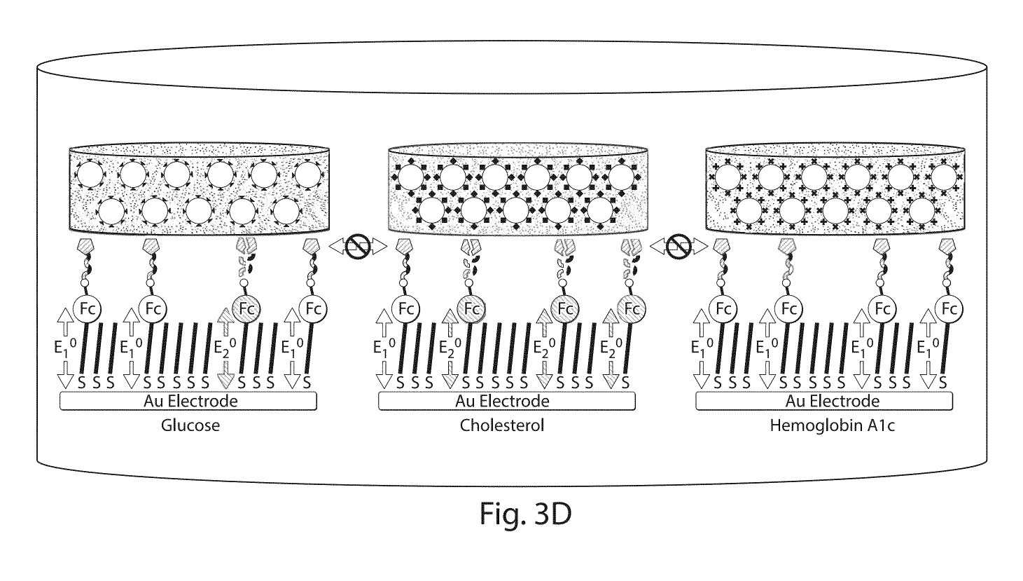

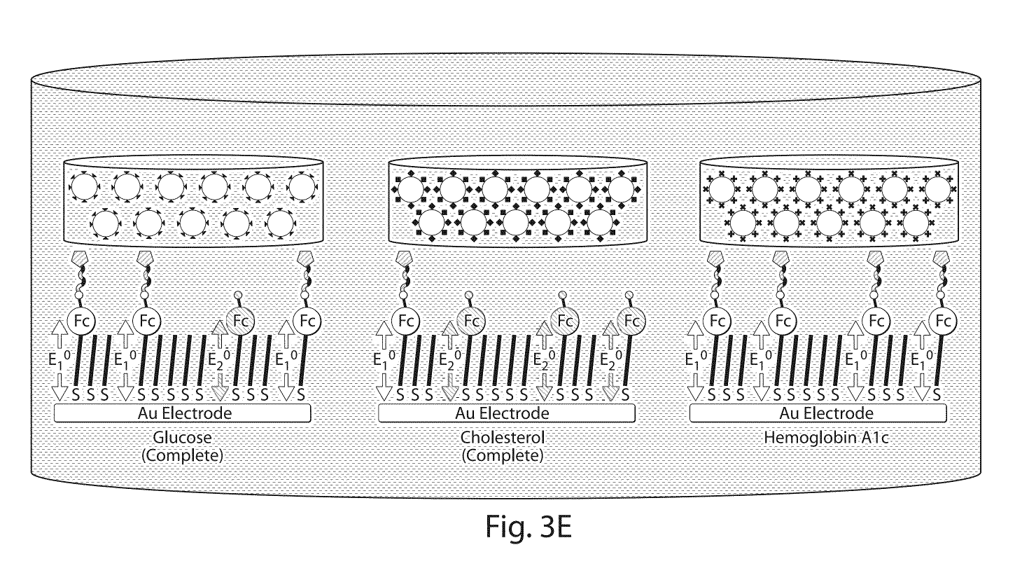

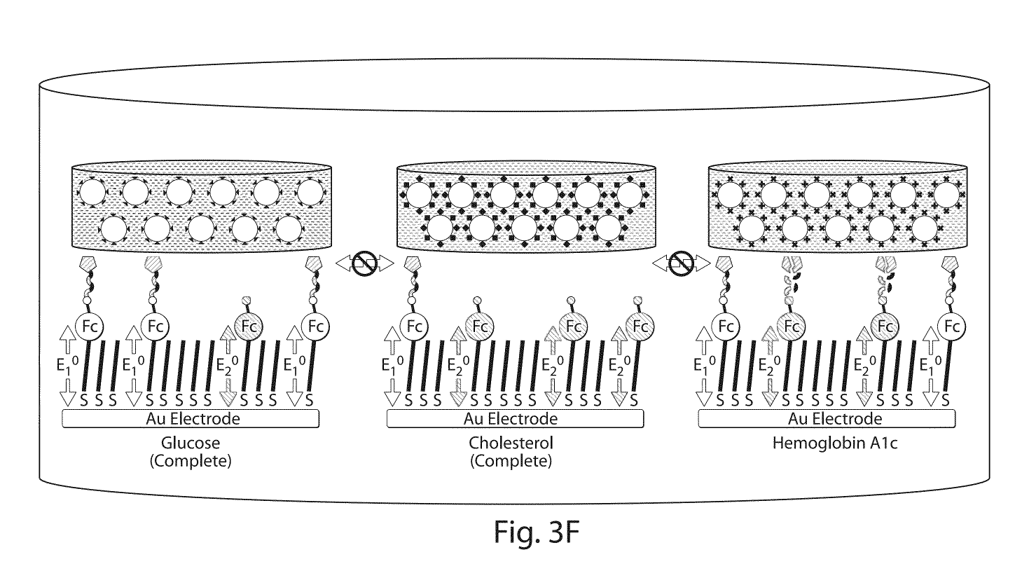

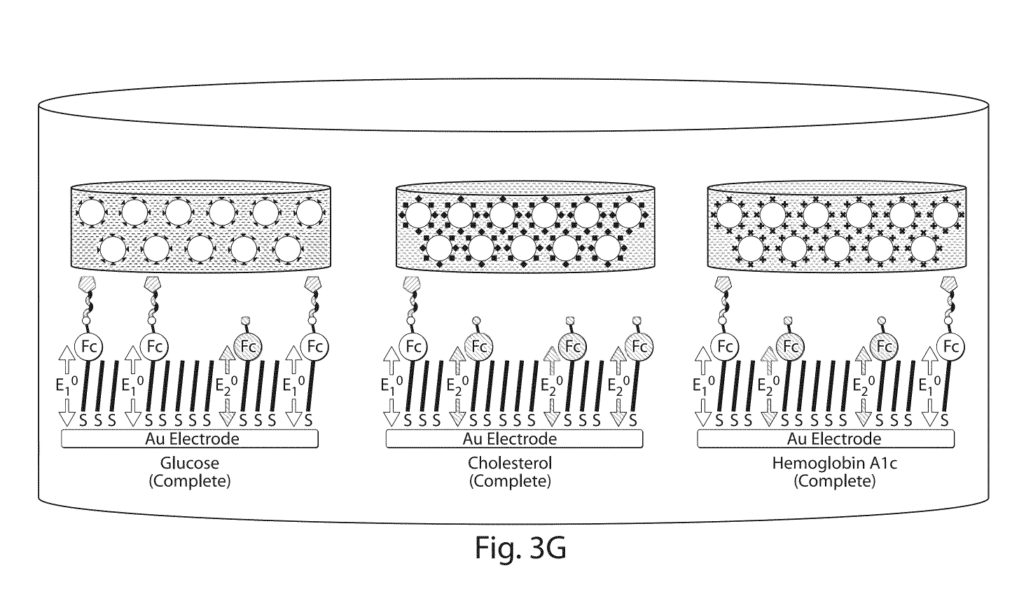

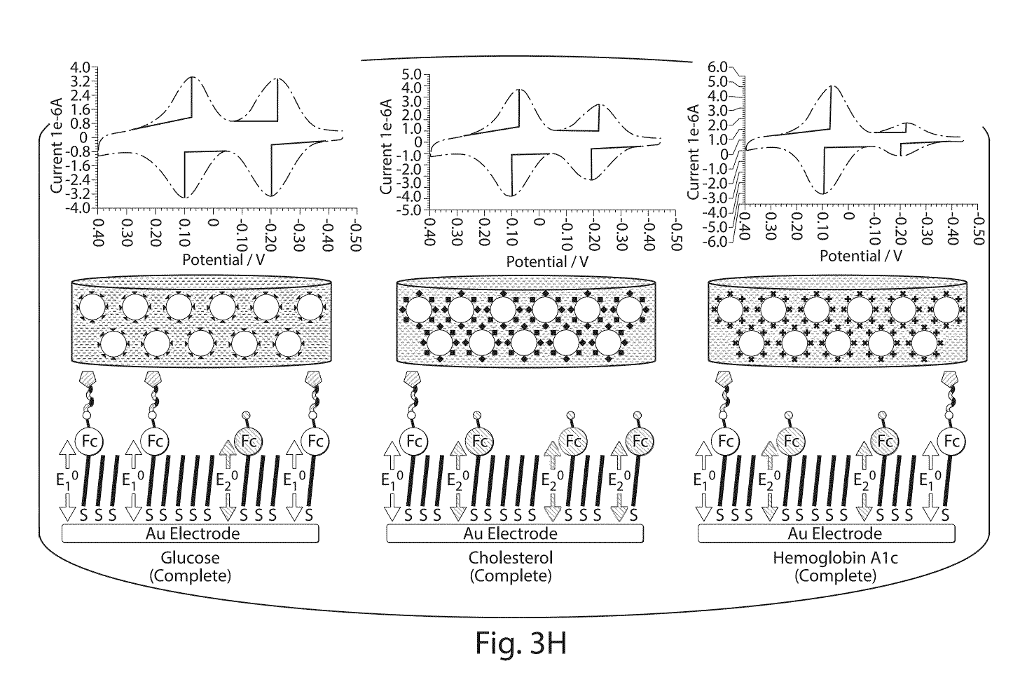

A non-limiting example of a method for multiplexing is shown in FIGS. 3A-H. In some embodiments, method for multiplexing may optionally comprise forming an array of porous substrates comprising immobilized assay component(s) for different target analytes. For instance, as shown in FIG. 3A, porous substrates may be prepared by immobilizing particles (e.g., magnetic beads) having a target specific detection component (e.g., target specific capture antibody and/or enzyme) attached thereto in the porous substrate (e.g., membrane). For example, as illustrated in FIG. 3A, one porous substrate may comprise immobilized particles having glucose oxidase (GOX) attached thereto, one porous substrate may comprise immobilized particles having cholesterol oxidase (CholOx) attached thereto, and one porous substrate may comprise immobilized particles having anti-hemoglobin antibody (HbPAb) attached thereto.

In some embodiments, the multiplexing method may optionally comprise forming a paired array of porous substrates and solid supports as illustrated in FIG. 3B. For example, as shown in FIG. 3B, the porous substrates prepared in FIG. 3A may be paired with an array of solid supports comprising electrodes comprising SAMs comprising EAMs comprising a redox active complex, PSM, and a SIM. In some instances, each electrode in the array is associated with a single porous substrate, thus each electrode in the array is prepared to detect a particular target. In some embodiments, at least a portion (e.g., all) of the porous substrate-solid support pairs in an array may be in fluid communication with one another during certain assay steps and/or may be contained within the same compartment, as shown in FIG. 3B. In some embodiments, the porous substrate and the solid support may be in direct contact with one another. In other embodiments, an intervening layer may be between the porous substrate and the solid support. In some embodiments, ratio of the area of the surface of the porous substrate in contact with the solid support to the area of the surface of the solid support and/or electrode in contact with the porous substrate may be between about 1:2 and about 2:1, between about 1:1.5 and about 1.5:1, between about 1:1.3 and about 1.3:1, or between about 1:1.1 and about 1.1:1. In some instances, the ratio may be about 1:1.

In some embodiments, a multiplexing method may comprise exposing a sample and/or certain reagents to the porous substrates in the compartment as shown in FIG. 3C. In some such embodiments, the porous substrates may be immersed in or saturated in the sample and/or reagents. In some instances, at least a portion (e.g., each) of the porous supports in the same compartment may be in fluid communication. For example, a sample-reagent solution may fill a compartment containing an array of porous substrate-solid support pairs, saturating each of the porous substrates. In the presence of the solution, the porous substrate may be in liquid communication with one another.

In some embodiments, after exposure to the sample and/or certain reagents, the sample may be removed from the compartment as shown in FIG. 3D. In some such embodiments, at least a portion of the sample and/or reagent solution may be retained in at least a portion of the (e.g., each) porous substrates. In such cases, the porous substrates may be isolated from one another in terms of physical contact and liquid communication. That is, in certain embodiments, the exchange of material (e.g., liquid) between the porous substrates may be substantially hindered as shown in FIG. 3D, and the porous substrate may be positioned so they are not in physical contact. For example, as illustrated in FIG. 3D, when the sample reagent solution shown in FIG. 3C is removed, only the porous substrates retain the sample-reagent solution, each independently of the other porous substrates. The space between the porous substrates may contain a relatively low amount of liquid after a removal step. For instance, in some embodiments, the volume percent of liquid in the space between two or more (e.g., all) porous substrates in an array that is occupied by liquid may be less than or equal to about 10%, less than or equal to about 8%, less than or equal to about 5%, less than or equal to about 3%, less than or equal to about 2%, less than or equal to about 1%, less than or equal to about 0.5%, or less than or equal to about 0.1%. In some embodiments, the space between two or more (e.g., all) porous substrates in an array may be substantially dry.

In some embodiments, at least a portion (e.g., each) of the solid supports comprising an electrode are in contact with only its associated porous substrate and the components therein. For instance, each electrode may only be in electrical communication with its associated porous substrate, such that only the components in its associated porous substrate may be electrically detected. For example, as illustrated in FIG. 3D, for a porous substrates containing oxidase, the enzymatic reaction between the target-specific enzyme (e.g., glucose oxidases, cholesterol oxidase) and any target in the sample will occur within the porous substrate and result in the production of hydrogen peroxide within the porous substrate. The hydrogen peroxide will be produced in proportion to the amount of target present in the sample. This hydrogen peroxide can reach the electrode directly below the porous substrate and react with the PMS of the EAM of the electrode, but cannot reach any other electrodes within the compartment. That is, referring to FIG. 3D, in some embodiments, the porous substrate with immobilized glucose oxidase allows an amount of hydrogen peroxide proportional to the amount of glucose in the original sample to reach and react with the electrode beneath it, but the amount of glucose may not affect the electrochemical signal produced from the other electrodes in the compartment. In some such embodiments, the hydrogen peroxide produced as a result of the glucose oxidase activity reacts only with the PSM, causing removal of the SIM, causing a detectible change in E⁰ of the EAM on its associated individual electrode in the array.

In some embodiments, the porous substrates may be exposed to a set of conditions that would generate peroxide in the presence of the target analyte. In some embodiments, the set of conditions is a solution comprising one or more assay components necessary for hydrogen peroxide generation. In some such embodiments, the porous substrates may be immersed in or saturated in the solution comprising one or more assay components. In some instances, at least a portion (e.g., each) of the porous supports in the same compartment may be in fluid communication. For example, a solution comprising the assay components may fill a compartment containing the array of porous substrate-solid support pairs, saturating each of the porous substrates. After sufficient exposure to the solution comprising the one or more assay components necessary for hydrogen peroxide generation, the solution may be removed from the compartment. In some such embodiments, at least a portion of the solution may be retained in at least a portion (e.g., each) of porous substrates. In such cases, the porous substrates may be isolated from one another in terms of physical contact and liquid communication. That is, in certain embodiments, the exchange of material (e.g., liquid) between the porous substrates may be substantially hindered.

In some embodiments, the set of conditions necessary for hydrogen peroxide generation after exposure to the sample may be substantially the same for two or more porous substrates in an array. In some such cases, hydrogen peroxide may be produced in two or more porous substrates at similar or substantially the same time. In certain embodiments, the change in electrical potential at each of the associated electrodes may be measured concurrently or sequentially.

In some embodiment, the set of conditions necessary for hydrogen peroxide generation after exposure to the sample may differ for two or more porous substrates in an array. In some such embodiments, the porous substrates may be exposed to the assay components needed to produce hydrogen peroxide in one porous substrate. That is, the porous substrates may be immersed in or saturated in the assay components, such that at least a portion of the porous substrates in fluid communication with one another are exposed to extraneous assay components. The solution may be removed as described above with respect to the sample. In some instances, the porous substrates may be exposed to other assay components needed to produce hydrogen peroxide in a different porous substrate, which may subsequently be removed. This process may continue until at least a portion (e.g., all) of the porous substrates are exposed to the assay components necessary to produce hydrogen peroxide. In some embodiments, the porous substrates may be washed after exposure to at least a portion (e.g., each) of the different solutions. It has been surprisingly found that exposure of porous substrates to various extraneous assay components does not substantially negatively affect assay performance.

A non-limiting example of exposure of certain porous substrates to extraneous assay components is illustrated in FIGS. 3E-3H. FIG. 3E shows the addition of substrates for the detection of hemoglobin A1c after removal of the sample from the compartment, as described above. The solution comprising the substrates may be removed and as shown in FIG. 3F. FIG. 3F shows that the amplification solution may also be removed to isolate the solution within the porous substrates. The amplification may be allowed to proceed to produce hydrogen peroxide, which can reach and react with the electrode directly below the porous substrate as in FIG. 3D. Isolation of the solution within the porous substrate prevents cross reactivity with other electrodes as peroxide is produced. FIG. 3G shows the array of electrodes within the compartment (e.g., well) after all assay reactions have completed. Each electrode has been modified proportionally to the amount of a specific target present in the original sample. FIG. 3H shows the addition of testing solution to the compartment (e.g., well) and the independent signal produced by each electrode in the array.

Specific multiplex and electrochemical assay methods are now described in more detail.

That is, in some embodiments, to determine whether multiple target analytes are present in a sample, the sample is added to a well containing an array of porous substrates and an associated array of solid supports, wherein each porous substrate has been modified with a different target-specific capture binding ligand or solid particles modified with target-specific capture binding ligands, each solid support comprises an electrode comprising EAMs comprising SIMs and PSMs, and each porous substrate of the array is associated with a single solid support of the array, such that each target of interest, if present in the sample, binds to the capture binding ligands of the corresponding porous substrate in the array. Excess sample is removed, isolating bound targets within each porous substrate. The array is optionally washed, and contacted with a solution contain secondary target specific binding ligands for each target, wherein each secondary binding ligand binds an alternative epitope of the target analyte and is tagged with a peroxide generating moiety or part of a peroxide generating system. Excess solution is removed, isolating bound ligand-target-ligand sandwiches within each porous substrate, and the array is optionally washed. Amplification solution containing all necessary substrates for all the peroxide generating moieties and/or the peroxide generating systems is added to saturate the array of porous substrates and immediately removed to isolate each component of the array, preventing cross-reactivity. Peroxide generated in proportion to the amount of target contained within each porous substrate of the array reacts with the PSM of only the associated solid support, causing removal of the SIMs resulting in a change in the E⁰ of the EAMs on each electrode independently of the others in the array. That is, each electrode in the array will produce a signal indicative of the concentration of one target of interest in the sample, and when measured together, the array provides results for all targets of interest.

In some embodiments, to determine whether multiple target analytes that are substrates of a peroxide generating moiety or are part of a peroxide generating system are present in a sample, the sample and any necessary components of the peroxide generating system is added to a well containing an array of porous substrates and an associated array of solid supports, wherein each porous substrate has been modified with a different target-specific oxidase enzyme or remaining necessary components of a peroxide generating system, each solid support comprises an electrode comprising EAMs comprising SIMs and PSMs, and each porous substrate of the array is associated with a single solid support of the array. The sample is immediately removed once the porous substrates have been saturated, isolating each porous substrate and its contents from the other solid supports in the array, preventing cross-reactivity. If present in the sample, target analytes react with the corresponding peroxide generating system in one porous substrate in the array. Peroxide generated in proportion to the amount of target contained within each porous substrate of the array reacts with the PSM of only the associated solid support, causing removal of the SIMs resulting in a change in the E⁰ of the EAMs on each electrode independently of the others in the array. That is, each electrode in the array will produce a signal indicative of the concentration of one target of interest in the sample, and when measured together, the array provides results for all targets of interest.

In some embodiments, the porous substrates of the array may be dissociated from the solid supports mid-assay to facilitate flow-through washing, then re-associated with same the solid support of the array for further assay steps. In some embodiments, when the porous substrates are removed from the solid supports, the porous substrates are brought in contact with absorbent material to facilitate movement of wash solution through the matrix of the porous substrate.

In some embodiments, these methods may also be used to detect a target enzyme of interest. In some embodiments, this can be done by immobilizing an enzymatic substrate in the matrix of a solid support such that the target enzyme can act on it, wherein the enzymatic product is either hydrogen peroxide or can be used in an enzyme cascade to produce hydrogen peroxide, i.e., is part of a peroxide generating system. Alternatively, a capture ligand specific for the target enzyme of interest could be immobilized in the matrix of the solid support such that the target enzyme retains activity once bound, and is subsequently contacted with a substrate that produces peroxide or a substrate that produces a product that can be used in an enzyme cascade to produce peroxide along with the necessary components of the enzyme cascade, i.e., is part of a peroxide generating system.

Accordingly, the certain inventive methods and compositions for detecting single or multiple target analytes in samples are described herein. The format chosen may vary depending on the target analyte(s) of interest, and any of the aforementioned methods can be combined to create a multiplex assay appropriate for the targets. As will also be appreciated by those in the art, in some formats the secondary soluble binding ligand(s) and/or necessary components for the enzyme cascades can be added to the sample containing the target analyte prior to addition to the porous substrate or array of porous substrates. Additionally, as will be appreciated by those in the art, several steps may be combined and done simultaneously instead of sequentially, and vice versa.

In some embodiments, the amount of mediator produced is proportional to the amount of target present in the sample. Thus, in some embodiments, the amount of target present in a sample can be detected through a change in E⁰ of an EAM. The change in the electrical potential may be detected at and/or near the solid support.

Typically EAMs are part of a self-assembled monolayer (SAM) that is pre-formed prior to being exposed to a target sample. Generally, the detection is attained through a substituent on a ferrocene that induces a change in potential in the presence of the target. This change in potential can be triggered by a chemical reaction (US20110033869) or enzymatic action (US20140027310). In application US20140027309 methods were described for reacting EAMs in the solution phase as a way to enhance the reaction rate between a mediator and an EAM before forming a heterogeneous SAM composed of both the reacted and unreacted products in some embodiments. Such methods may also be utilized here and are incorporated by reference in their entirety.

In some embodiments, the immobilized support comprising one or more assay components may be used in an electrochemical detection method to eliminate several complexities common to immunoassays, such as bead handling and sandwich isolation. In certain embodiments, the electrochemical detection method may utilize the conversion of functional groups attached to a transitional metal complex resulting in quantifiable electrochemical signal at two unique potentials, E⁰₁ and E⁰₂ as described in U.S. Patent Publication Nos. US 2011 0033869 and US 2012-0181186, all herein incorporated by reference in their entirety. In some such cases, the electrochemical detection method may utilize signal amplification strategies that rely on target-dependent enzyme cascades for generating hydrogen peroxide. The methods generally comprise binding an analyte within a sandwich of binding ligands which may have a functional tag, on a solid support other than the electrode. After target binding, a peroxide generating moiety or an intermediary enzyme and substrate can be added which generates hydrogen peroxide. The redox active complex is bound to an electrode and comprises a peroxide sensitive moiety (PSM) in such examples. The peroxide generated from the enzyme system reacts with the PSM, removing a self-immolative moiety (SIM) and converting functional groups attached to a transitional metal complex resulting in quantifiable electrochemical signal at two unique potentials, E⁰₁ and E⁰₂. This application describes a detection scheme whereby the change in E⁰ is measured as an indicator of a target analyte in a sample.

Non-limiting examples of enzyme cascades for generating hydrogen peroxide are described in more detail below. One example of a cascade includes alkaline phosphatase (AP), which catalyzes the dephosphorylation of FADP to yield FAD, an enzyme cofactor that turns “on” a dormant apo-D-amino acid oxidase (D-AAO). In turn, each active D-AAO generated oxidizes D-proline and produces hydrogen peroxide which is detected using the Ohmx E-TRACE technology, which is described in U.S. Patent Publication No. US 20120181186, filed Jan. 19, 2012 which claims the benefit of priority to U.S. provisional application Nos. 61/434,122, filed Jan. 19, 2011 and 61/523,679, filed Aug. 15, 2011 and Ser. No. 12/853,204, filed Aug. 9, 2010, which claims the benefit of priority to U.S. provisional application Nos. 61/232,339, filed Aug. 7, 2009, and in U.S. patent application Ser. No. 13/653,931, filed Oct. 17, 2012, all which are incorporated by reference in their entirety.

In some embodiments, a solid support comprising an electrode is used. In some embodiments, the EAM forms a self-assembled monolayer (SAM) on the solid support. The electrode may be used to measure an electrical signal, and in a preferred embodiment, the electrode is used to measure E⁰ of an EAM self-assembled into a monolayer on the solid support.

In some embodiments, a second soluble binding ligand specific for the target is introduced, wherein the ligand comprises a peroxide generating moiety, such as an oxidase enzyme. Upon the addition of oxygen and a substrate for the peroxidase generating moiety (e.g., an oxygen saturated buffer and glucose, in the case of a glucose oxidase enzyme as the peroxidase generating moiety) peroxide is generated, reacting with the PSM of the EAM and causing the removal of the self-immolative moiety from the EAM, which results in a change in the E⁰ of the EAM. This change in E⁰ is detected, and if such a change occurs, it is an indication of the presence of the target analyte.

Target Analytes

By “target analyte” or “analyte” or “target” or grammatical equivalents herein is meant any molecule, compound, or particle to be detected. Target analytes may bind to binding ligands (both capture and soluble binding ligands), binding ligands attached to or within a solid support, and/or a solid support itself, as is more fully described below.

Suitable analytes include organic and inorganic molecules, including biomolecules. In one embodiment, the analyte may be an environmental pollutant (including pesticides, insecticides, toxins, etc.); a chemical (including solvents, polymers, organic materials, etc.); therapeutic molecules (including therapeutic and abused drugs, antibiotics, etc.); biomolecules (including hormones, cytokines, proteins, lipids, carbohydrates, cellular membrane antigens and receptors (neural, hormonal, nutrient, and cell surface receptors) or their ligands, etc); whole cells (including procaryotic (such as pathogenic bacteria) and eukaryotic cells, including mammalian tumor cells); viruses (including retroviruses, herpesviruses, adenoviruses, lentiviruses, etc.); and spores; etc.

In some embodiments, the target analyte is a protein. As will be appreciated by those in the art, there are a large number of possible proteinaceous target analytes that may be detected using the present invention. By “proteins” or grammatical equivalents herein is meant proteins, oligopeptides and peptides, derivatives and analogs, including proteins containing non-naturally occurring amino acids and amino acid analogs, and peptidomimetic structures. The side chains may be in either the (R) or the (S) configuration. In a preferred embodiment, the amino acids are in the (S) or L configuration. When the protein is used as a binding ligand, it may be desirable to utilize protein analogs to retard degradation by sample contaminants.

Suitable protein target analytes include, but are not limited to, (1) immunoglobulins, particularly IgEs, IgGs and IgMs, and particularly therapeutically or diagnostically relevant antibodies, including but not limited to, for example, antibodies to human albumin, apolipoproteins (including apolipoprotein E), human chorionic gonadotropin, cortisol, α-fetoprotein, thyroxin, thyroid stimulating hormone (TSH), antithrombin, antibodies to pharmaceuticals (including antieptileptic drugs (phenytoin, primidone, carbariezepin, ethosuximide, valproic acid, and phenobarbitol), cardioactive drugs (digoxin, lidocaine, procainamide, and disopyramide), bronchodilators (theophylline), antibiotics (chloramphenicol, sulfonamides), antidepressants, immunosuppresants, abused drugs (amphetamine, methamphetamine, cannabinoids, cocaine and opiates) and antibodies to any number of viruses (including orthomyxoviruses, (e.g. influenza virus), paramyxoviruses (e.g., respiratory syncytial virus, mumps virus, measles virus), adenoviruses, rhinoviruses, coronaviruses, reoviruses, togaviruses (e.g. rubella virus), parvoviruses, poxviruses (e.g. variola virus, vaccinia virus), enteroviruses (e.g. poliovirus, coxsackievirus), hepatitis viruses (including A, B and C), herpesviruses (e.g. Herpes simplex virus, varicella zoster virus, cytomegalovirus, Epstein Barr virus), rotaviruses, Norwalk viruses, hantavirus, arenavirus, rhabdovirus (e.g. rabies virus), retroviruses (including HIV, HTLV I and II), papovaviruses (e.g. papillomavirus), polyomaviruses, and picornaviruses, and the like), and bacteria (including a wide variety of pathogenic and non pathogenic prokaryotes of interest including Bacillus; Vibrio, e.g. V. cholerae; Escherichia, e.g. Enterotoxigenic E. coli, Shigella, e.g. S. dysenteriae; Salmonella, e.g. S. typhi; Mycobacterium e.g. M. tuberculosis, M. leprae; Clostridium, e.g. C. botulinum, C. tetani, C. difficile, C. perfringens; Cornyebacterium, e.g. C. diphtheriae; Streptococcus, S. pyogenes, S. pneumoniae; Staphylococcus, e.g. S. aureus; Haemophilus, e.g. H. influenzae; Neisseria, e.g. N. meningitidis, N. gonorrhoeae; Yersinia, e.g. G. lamblia Y. pestis, Pseudomonas, e.g. P. aeruginosa, P. putida; Chlamydia, e.g. C. trachomatis; Bordetella, e.g. B. pertussis; Treponema, e.g. T. palladium; and the like); (2) enzymes (and other proteins), including but not limited to, enzymes used as indicators of or treatment for heart disease, including creatine kinase, lactate dehydrogenase, aspartate amino transferase, troponin T, troponin I, myoglobin, fibrinogen, cholesterol, triglycerides, thrombin, tissue plasminogen activator (tPA); pancreatic disease indicators including amylase, lipase, chymotrypsin and trypsin; liver function enzymes and proteins including cholinesterase, bilirubin, and alkaline phosphotase; aldolase, prostatic acid phosphatase, terminal deoxynucleotidyl transferase, bacterial and viral enzymes such as HIV protease, and other relevant enzymes; (3) hormones and cytokines (many of which serve as ligands for cellular receptors) such as erythropoietin (EPO), thrombopoietin (TPO), the interleukins (including IL-1 through IL-17), insulin, insulin-like growth factors (including IGF-1 and -2), epidermal growth factor (EGF), transforming growth factors (including TGF-α and TGF-β), human growth hormone, transferrin, epidermal growth factor (EGF), low density lipoprotein, high density lipoprotein, leptin, VEGF, PDGF, ciliary neurotrophic factor, prolactin, adrenocorticotropic hormone (ACTH), calcitonin, procalcitonin, human chorionic gonadotropin (HCG), cotrisol, estradiol, follicle stimulating hormone (FSH), thyroid-stimulating hormone (TSH), leutinzing hormone (LH), progeterone, or testosterone; and (4) other proteins (including α-fetoprotein, carcinoembryonic antigen (CEA)).

In addition, any of the biomolecules for which antibodies may be detected may be detected directly as well; that is, detection of virus or bacterial cells, therapeutic and abused drugs, etc., may be done directly.

Suitable target analytes include carbohydrates, including but not limited to, markers for breast cancer (CA15-3, CA 549, CA 27.29), mucin-like carcinoma associated antigen (MCA), ovarian cancer (CA125), pancreatic cancer (DE-PAN-2), and colorectal and pancreatic cancer (CA 19, CA 50, CA242).

Targets include small molecules such as glucose or cholesterol or ATP, FADP, NADH and other metabolites, or hormones, such as testosterones etc, or proteins such as thyroid stimulating hormone, troponin I etc. Targets may also include nucleic acids or sequences of nucleic acids (e.g. DNA, RNA, mRNA, etc.).

Target analytes of the disclosure may be labeled. Thus, by “labeled target analyte” herein is meant a target analyte that is labeled with a member of a specific binding pair.

By “target specific detection components” or other grammatical equivalents herein is meant components which specifically react with the target in such a way as to enable the generation of a signal indicating the presence of a target. In some embodiments the target specific detection components are immobilized with porous substrates. In some embodiments, target specific detection components are used to modify the porous substrates to make the porous substrate specific for a particular target of interest. In some embodiments, the target specific detection components may comprise capture ligands, while in other embodiments, these may comprise components which specifically react with the target, for example, enzymes or enzymatic substrates. They may be components that are used as part of a standard sandwich format assay, or they may be part of a target-dependent peroxide generating system. As will be appreciated by those is the art, the target specific detection components may be used or immobilized within solid supports independently, or may be coupled to additional solid particles before immobilization with the solid supports. In some embodiments, magnetic beads find particular use as the solid particles. As will be appreciated by those in the art, a vast number of possible detection components exist for targets of interest, and can be selected appropriately. As non-limiting examples of target/target specific detection components, protein/antibody, enzyme/substrate, substrate/enzyme, protein/aptamer, and nucleic acid sequence/complementary nucleic acid sequence may be used.

Samples

The target analytes are generally present in samples. As will be appreciated by those in the art, the sample solution may comprise any number of things, including, but not limited to, bodily fluids (including, but not limited to, blood, urine, serum, lymph, saliva, anal and vaginal secretions, perspiration, tears, prostatic fluid, and semen samples of virtually any organism, with mammalian samples being preferred and human samples being particularly preferred); environmental samples (including, but not limited to, air, agricultural, water and soil samples); plant materials; biological warfare agent samples; research samples; purified samples; raw samples; etc. As will be appreciated by those in the art, virtually any experimental manipulation and/or sample preparation may have been done on the sample. Some embodiments utilize target samples from stored (e.g. frozen and/or archived) or fresh tissues. Paraffin-embedded samples are of particular use in some embodiments, as these samples can be very useful due to the presence of additional data associated with the samples, such as diagnosis and prognosis. Fixed and paraffin-embedded tissue samples as described herein refers to storable or archival tissue samples. Most patient-derived pathological samples are routinely fixed and paraffin-embedded to allow for histological analysis and subsequent archival storage.

Porous Substrate

In some embodiments, methods for detecting at least one target analyte in a sample by utilizing a porous substrate to immobilize several components are provided. Porous substrates are used to immobilize target specific detection components. In some embodiments, this includes immobilizing capture ligands, solid particles modified with capture ligands, targets, and/or sandwiches of capture binding ligand-target-secondary binding ligand. The target analytes are also detected using solid supports comprising electrodes.

Membranes and filters find particular use as porous substrates. In some embodiments, capture ligands may be immobilized within the matrix of the porous substrate. In some embodiments, solid particles modified with capture ligands may be immobilized within the matrix of the porous substrate. The use of porous substrates can ensure direct and irreversible immobilization of some assay components. Such methods may eliminate several complexities common to immunoassays, such as bead handling and sandwich isolation. The use of such a porous substrate can also improve the efficiency of wash steps. Capture ligand, target, and secondary binding ligand bound within the matrix of the porous substrate will be held in place, while any unbound, excess, or extraneous materials can move freely through and out of the matrix. This allows washing to be carried out both by flushing straight through, or by drawing the wash solution and unbound materials back out the point of entry. Better wash efficiency reduces background noise or false signals, improving the quality of results. The use of such a porous substrate also eliminates the need for performing additional sandwich isolation steps as the sandwich is formed and held directly within the porous substrate. This reduces the number and complexity of assay steps required, and may shorten assay time as well. Such porous substrates can also be used to isolate multiple reaction components within the same reaction chamber.

In some embodiments, the porous substrate may immobilize target specific detection components. In some embodiments, the porous substrate comprises a membrane or filter wherein capture binding ligands specific for a target of interest are immobilized or embedded within the matrix of the porous substrate. In some embodiments, the porous substrate comprises a membrane or filter wherein solid particles are embedded within the matrix of the membrane, wherein the solid particles are modified with a capture binding ligand specific for a target of interest. In a preferred embodiment, the modified solid particles are beads.

In some embodiments, the porous substrates and the porous substrates can be arranged into an array format. See FIG. 2 for an example of an array format. In some embodiments, the porous substrate in the array can be modified to correspond to a different target of interest. In some embodiments, each modified porous substrate of an array can be associated with an array of solid supports, wherein each solid support in the array comprised an electrode, the association allowing each electrode of the array to produce a signal dependent on the presence of a specific target within a sample.

In some embodiments, the porous substrate may have an average pore size of between about 0.1 microns and about 1.0 microns, between about 0.2 microns and about 0.8 microns, between about 0.2 microns and about 0.6 microns, or between about 0.2 microns and about 0.4 microns. In some embodiments, porous substrates with an average pore size between about 0.2 microns to 0.4 microns may be used.

In general, the porous substrates may be composed of any suitable material. Non-limiting examples of suitable porous substrates include filter media, polymeric membranes (e.g., polyethylene), fiberglass, teflon, ceramics, mica, plastic (including acrylics, polystyrene and copolymers of styrene and other materials, polypropylene, polyethylene, polybutylene, polyimide, polycarbonate, polyurethanes, Teflon™, and derivatives thereof, etc.), GETEK (a blend of polypropylene oxide and fiberglass), etc, polysaccharides, nylon or nitrocellulose, resins, porous silica or silica-based materials including silicon and modified silicon, carbon, metals, inorganic glasses and a variety of other polymers, with membranes and filters being particularly preferred.

In some embodiments, the porous substrate may be hydrophilic. For instance, in some embodiments, the water contact angle of the porous substrate may be less than about 90° (e.g., less than or equal to about 75°).

Solid Supports

By “solid support” or other grammatical equivalents herein is meant any material that can be modified to contain discrete individual sites appropriate of the attachment or association of capture ligands or electrode components. Suitable substrates include metal surfaces such as gold, electrodes as defined below, glass and modified or functionalized glass, fiberglass, teflon, ceramics, mica, plastic (including acrylics, polystyrene and copolymers of styrene and other materials, polypropylene, polyethylene, polybutylene, polyimide, polycarbonate, polyurethanes, Teflon™, and derivatives thereof, etc.), GETEK (a blend of polypropylene oxide and fiberglass), etc, polysaccharides, nylon or nitrocellulose, resins, silica or silica-based materials including silicon and modified silicon, carbon, metals, inorganic glasses and a variety of other polymers, with membranes, filters, and printed circuit board (PCB) materials being particularly preferred.

The present system finds particular utility in array formats, i.e., wherein there is a matrix of addressable detection electrodes (which may be referred to as “pads”, “addresses” or “micro-locations”) and corresponding porous substrates containing specific capture ligands. By “array” herein is meant a plurality of solid supports in an array format. The size of the array will depend on the composition and end use of the array. Arrays containing from two to many thousands of different solid supports can be made. As used herein, “array” may also refer to a plurality of porous substrates in an array format, or a plurality of both solid supports and porous substrates arranged in an array format, particularly wherein each porous substrate is associated with a single solid support in the array.

In a preferred embodiment, the detection electrodes are formed on a substrate. In addition, the discussion herein is generally directed to the use of gold electrodes, but as will be appreciated by those in the art, other electrodes can be used as well. The substrate can comprise a wide variety of materials, as outlined herein and in the cited references.

In general, preferred materials include printed circuit board materials. Circuit board materials are those that comprise an insulating substrate that is coated with a conducting layer and processed using lithography techniques, particularly photolithography techniques, to form the patterns of electrodes and interconnects (sometimes referred to in the art as interconnections or leads). The insulating substrate is generally, but not always, a polymer. As is known in the art, one or a plurality of layers may be used, to make either “two dimensional” (e.g. all electrodes and interconnections in a plane) or “three dimensional” (wherein the electrodes are on one surface and the interconnects may go through the board to the other side or wherein electrodes are on a plurality of surfaces) boards. Three dimensional systems frequently rely on the use of drilling or etching, followed by electroplating with a metal such as copper, such that the “through board” interconnections are made. Circuit board materials are often provided with a foil already attached to the substrate, such as a copper foil, with additional copper added as needed (for example for interconnections), for example by electroplating. The copper surface may then need to be roughened, for example through etching, to allow attachment of the adhesion layer.

Accordingly, in a preferred embodiment, the present invention provides chips (sometimes referred to herein as “biochips”) that comprise substrates comprising a plurality of electrodes, preferably gold electrodes. The number of electrodes is as outlined for arrays. Each electrode preferably comprises a self-assembled monolayer as outlined herein. In a preferred embodiment, one of the monolayer-forming species comprises an electroactive moiety (EAM) as outlined herein. In addition, each electrode has an interconnection, that is, each electrode is ultimately attached to a device that can control the electrode. That is, each electrode is independently addressable.

Finally, the compositions of the invention can include a wide variety of additional components, including microfluidic components and robotic components (see for example U.S. Pat. Nos. 6,942,771 and 7,312,087 and related cases, both of which are hereby incorporated by reference in its entirety), and detection systems including computers utilizing signal processing techniques (see for example U.S. Pat. No. 6,740,518, hereby incorporated by reference in its entirety).

Electrodes

In some embodiments the solid supports of the invention comprise electrodes. By “electrodes” herein is meant a composition, which, when connected to an electronic device, is able to sense a current or charge and convert it to a signal. Preferred electrodes are known in the art and include, but are not limited to, certain metals and their oxides, including gold, platinum, palladium, silicon, aluminum; metal oxide electrodes including platinum oxide, titanium oxide, tin oxide, indium tin oxide, palladium oxide, silicon oxide, aluminum oxide, molybdenum oxide (Mo2O6), tungsten oxide (WO3) and ruthenium oxides; and carbon (including glassy carbon electrodes, graphite, and carbon paste). Preferred electrodes include gold, silicon, carbon, and metal oxide electrodes, with gold being particularly preferred.

The electrodes described herein are depicted as a flat surface, which is only one of the possible conformations of the electrode and is for schematic purposes only. The conformation of the electrode will vary with the detection method used.

The electrodes of the invention can be incorporated into cartridges and can take a wide variety of configurations, and can include working and reference electrodes, interconnects (including “through board” interconnects), and microfluidic components. See for example U.S. Pat. No. 7,312,087, incorporated herein by reference in its entirety. In addition, the chips generally include a working electrode with the components described herein, a reference electrode, and a counter/auxiliary electrode.

In a preferred embodiment, detection electrodes consist of an evaporated gold circuit on a polymer backing.

The cartridges include substrates comprising the arrays of biomolecules, and can be configured in a variety of ways. For example, the chips can include reaction chambers with inlet and outlet ports for the introduction and removal of reagents. In addition, the cartridges can include caps or lids that have microfluidic components, such that the sample can be introduced, reagents added, reactions done, and then the sample is added to the reaction chamber containing at least one electrode for detection. Cartridges may also contain or incorporate solid support components such as membranes or filters. Cartridges may also contain a series of wells to hold and allow reaction of assay reagents and components. Cartridges may also contain arrays of solid supports, including arrays of membranes and associated arrays of electrode sensors.

Self Assembled Monolayers

In some embodiments the electrodes comprise a self-assembled monolayer (SAM). By “monolayer” or “self-assembled monolayer” or “SAM” or grammatical equivalents herein is meant a relatively ordered assembly of molecules spontaneously chemisorbed on a surface, in which the molecules are oriented approximately parallel to each other and roughly perpendicular to the surface. Each of the molecules includes a functional group that adheres to the surface, and a portion that interacts with neighboring molecules in the monolayer to form the relatively ordered array. A “mixed” monolayer comprises a heterogeneous monolayer, that is, where at least two different molecule types make up the monolayer. As outlined herein, the use of a monolayer reduces the amount of non-specific binding of biomolecules to the surface, and, in the case of nucleic acids, increases the efficiency of oligonucleotide hybridization as a result of the distance of the oligonucleotide from the electrode. Thus, a monolayer facilitates the maintenance of the target away from the electrode surface. In addition, a monolayer serves to keep charge carriers away from the surface of the electrode. Thus, this layer helps to prevent electrical contact between the electrodes and the redox active moiety complexes, or between the electrode and charged species within the solvent. Such contact can result in a direct short circuit or an indirect short circuit via charged species which may be present in the sample. Accordingly, the monolayer is preferably tightly packed in a uniform layer on the electrode surface, such that a minimum of “holes” exist. The monolayer thus serves as a physical barrier to block solvent accessibility to the electrode.

In some embodiments, the monolayer comprises conductive oligomers, and in particular, conductive oligomers are generally used to attach the EAM to the electrode surface, as described below. By “conductive oligomer” herein is meant a substantially conducting oligomer, preferably linear, some embodiments of which are referred to in the literature as “molecular wires”. By “substantially conducting” herein is meant that the oligomer is capable of transferring electrons at or around 100 Hz. Generally, the conductive oligomer has substantially overlapping π-orbitals, i.e., conjugated π-orbitals, as between the monomeric units of the conductive oligomer, although the conductive oligomer may also contain one or more sigma (σ) bonds. Additionally, a conductive oligomer may be defined functionally by its ability to inject or receive electrons into or from an associated EAM. Furthermore, the conductive oligomer is more conductive than the insulators as defined herein. Additionally, the conductive oligomers of the invention are to be distinguished from electroactive polymers, that themselves may donate or accept electrons.

A more detailed description of conductive oligomers is found in WO11999157317, herein incorporated by reference in its entirety. In particular, the conductive oligomers as shown in Structures 1 to 9 on page 14 to 21 of WO11999157317 find use in the present invention. In some embodiments, the conductive oligomer has the following structure:

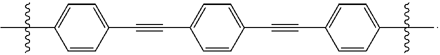 [SMILES: *c1ccc(C#Cc2ccc(C#Cc3ccc(*)cc3)cc2)cc1]

In addition, the terminus of at least some of the conductive oligomers in the monolayer is electronically exposed. By “electronically exposed” herein is meant that upon the placement of an EAM in close proximity to the terminus, and after initiation with the appropriate signal, a signal dependent on the presence of the EAM may be detected. The conductive oligomers may or may not have terminal groups. Thus, in a preferred embodiment, there is no additional terminal group, and the conductive oligomer terminates with a terminal group; for example, such as an acetylene bond. Alternatively, in some embodiments, a terminal group is added. A terminal group may be used for several reasons; for example, to contribute to the electronic availability of the conductive oligomer for detection of EAMs, or to alter the surface of the SAM for other reasons, for example to prevent non-specific binding. For example, there may be negatively charged groups on the terminus to form a negatively charged surface such that when the target analyte is nucleic acid such as DNA or RNA, the nucleic acid is repelled or prevented from lying down on the surface, to facilitate hybridization. Preferred terminal groups include —NH, —OH, —COOH, and alkyl groups such as —CH₃, and (poly)alkyloxides such as (poly)ethylene glycol, with —OCH₂CH₂OH, —(OCH₂CH₂O)₂H, —(OCH₂CH₂O)₃H, and —(OCH₂CH₂O)₄H being preferred.

In one embodiment, it is possible to use mixtures of conductive oligomers with different types of terminal groups. Thus, for example, some of the terminal groups may facilitate detection, and some may prevent non-specific binding.

In some embodiments, the electrode further comprises a passivation agent, preferably in the form of a monolayer on the electrode surface. For some analytes the efficiency of analyte binding (i.e. hybridization) may increase when the binding ligand is at a distance from the electrode. In addition, the presence of a monolayer can decrease non-specific binding to the surface (which can be further facilitated by the use of a terminal group, outlined herein). A passivation agent layer facilitates the maintenance of the binding ligand and/or analyte away from the electrode surface. In addition, a passivation agent serves to keep charge carriers away from the surface of the electrode. Thus, this layer also helps to prevent electrical contact between the electrodes and the electron transfer moieties, or between the electrode and charged species within the solvent. Such contact can result in a direct short circuit or an indirect short circuit via charged species which may be present in the sample. Accordingly, the monolayer of passivation agents is preferably tightly packed in a uniform layer on the electrode surface, such that a minimum of “holes” exist. Alternatively, the passivation agent may not be in the form of a monolayer, but may be present to help the packing of the conductive oligomers or other characteristics.

The passivation agents thus serve as a physical barrier to block solvent accessibility to the electrode. As such, the passivation agents themselves may in fact be either (1) conducting or (2) nonconducting, i.e., insulating, molecules. Thus, in one embodiment, the passivation agents are conductive oligomers, as described herein, with or without a terminal group to block or decrease the transfer of charge to the electrode. Other passivation agents which may be conductive include oligomers of —(CF₂)ₙ—, —(CHF)ₙ— and —(CFR)ₙ—. In a preferred embodiment, the passivation agents are insulator moieties.

In some embodiments, the monolayers comprise insulators. An “insulator” is a substantially nonconducting oligomer, preferably linear. By “substantially nonconducting” herein is meant that the rate of electron transfer through the insulator is slower than the rate of electron transfer through the conductive oligomer. Stated differently, the electrical resistance of the insulator is higher than the electrical resistance of the conductive oligomer. It should be noted however that even oligomers generally considered to be insulators, such as —(CH₂)₁₆ molecules, still may transfer electrons, albeit at a slow rate.

In some embodiments, the insulators have a conductivity, S, of about 10⁻⁷ Ω-1 cm⁻¹ or lower, with less than about 10⁻⁸ Ω-1 cm⁻¹ being preferred. Gardner et al., Sensors and Actuators A 51 (1995) 57-66, incorporated herein by reference.

Generally, insulators are alkyl or heteroalkyl oligomers or moieties with sigma bonds, although any particular insulator molecule may contain aromatic groups or one or more conjugated bonds. By “heteroalkyl” herein is meant an alkyl group that has at least one heteroatom, i.e. nitrogen, oxygen, sulfur, phosphorus, silicon or boron included in the chain. Alternatively, the insulator may be quite similar to a conductive oligomer with the addition of one or more heteroatoms or bonds that serve to inhibit or slow, preferably substantially, electron transfer. In some embodiments the insulator comprises C6-C16 alkyl.

The passivation agents, including insulators, may be substituted with R groups as defined herein to alter the packing of the moieties or conductive oligomers on an electrode, the hydrophilicity or hydrophobicity of the insulator, and the flexibility, i.e., the rotational, torsional or longitudinal flexibility of the insulator. For example, branched alkyl groups may be used. In addition, the terminus of the passivation agent, including insulators, may contain an additional group to influence the exposed surface of the monolayer, sometimes referred to herein as a terminal group (“TG”). For example, the addition of charged, neutral or hydrophobic groups may be done to inhibit non-specific binding, or to influence the kinetics of binding, etc. For example, there may be charged groups on the terminus to form a charged surface to prevent molecules from lying down on the surface of the electrode.

The length of the passivation agent will vary as needed. In some embodiments, the length of the passivation agents is similar to the length of the conductive oligomers, as outlined above. In some embodiments, the conductive oligomers may be basically the same length as the passivation agents or longer than them. Varying the relative lengths may result in the reactive groups being more or less accessible to peroxide.

The monolayer may comprise a single type of passivation agent, including insulators, or different types.

Suitable insulators are known in the art, and include, but are not limited to, —(CH₂)ₙ—, —(CRH)ₙ—, and —(CR₂)ₙ—, ethylene glycol or derivatives using other heteroatoms in place of oxygen, i.e. nitrogen or sulfur (sulfur derivatives are not preferred when the electrode is gold). In some embodiments, the insulator comprises C6 to C16 alkyl.

In some embodiments, the electrode is a metal surface and need not necessarily have interconnects or the ability to do electrochemistry.

Electroactive Moieties

In addition to the SAMs, the electrodes comprise an EAM. By “electroactive moiety (EAM)” or “transition metal complex” or “redox active molecule” or “electron transfer moiety (ETM)” herein is meant a metal-containing compound which is capable of reversibly or semi-reversibly transferring one or more electrons. In some embodiments, the redox active molecule may comprise a transition metal complex attached to a molecular wire and/or a self-immolative moiety (SIM) and/or a peroxide sensitive moiety (PSM). In some embodiments, the EAM may have a first E⁰ when the SIM is present, and a second E⁰ when the SIM is absent. The EAMs may form SAMs on the electrode. In some embodiments, EAM structures as described in US20130112572, hereby incorporated by reference in its entirety, are particularly preferred as EAM compositions.

It is to be understood that electron donor and acceptor capabilities are relative; that is, a molecule which can lose an electron under certain experimental conditions will be able to accept an electron under different experimental conditions.

It is to be understood that the number of possible transition metal complexes is very large, and that one skilled in the art of electron transfer compounds will be able to utilize a number of compounds in the present invention. By “transitional metal” herein is meant metals whose atoms have a partial or completed shell of electrons. Suitable transition metals for use in the invention include, but are not limited to, cadmium (Cd), copper (Cu), cobalt (Co), palladium (Pd), zinc (Zn), iron (Fe), ruthenium (Ru), rhodium (Rh), osmium (Os), rhenium (Re), platinum (Pt), scandium (Sc), titanium (Ti), Vanadium (V), chromium (Cr), manganese (Mn), nickel (Ni), Molybdenum (Mo), technetium (Tc), tungsten (W), and iridium (Ir). That is, the first series of transition metals, the platinum metals (Ru, Rh, Pd, Os, Ir and Pt), along with Fe, Re, W, Mo and Tc, find particular use in the present invention. Metals that find use in the invention also are those that do not change the number of coordination sites upon a change in oxidation state, including ruthenium, osmium, iron, platinum and palladium, with osmium, ruthenium and iron being especially useful. Generally, transition metals are depicted herein (or in incorporated references) as TM or M.

The transitional metal and the coordinating ligands form a metal complex. By “ligand” or “coordinating ligand” (depicted herein or in incorporated references in the figures as “L”) herein is meant an atom, ion, molecule, or functional group that generally donates one or more of its electrons through a coordinate covalent bond to, or shares its electrons through a covalent bond with, one or more central atoms or ions.

In some embodiments, small polar ligands are used; suitable small polar ligands, generally depicted herein as “L”, fall into two general categories, as is more fully described herein. In one embodiment, the small polar ligands will be effectively irreversibly bound to the metal ion, due to their characteristics as generally poor leaving groups or as good sigma donors, and the identity of the metal. These ligands may be referred to as “substitutionally inert”. Alternatively, as is more fully described below, the small polar ligands may be reversibly bound to the metal ion, due to their good leaving group properties or poor sigma donor properties. These ligands may be referred to as “substitutionally labile”.

Some of the structures of transitional metal complexes are shown below:

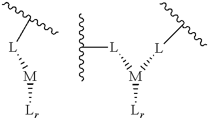

L are the co-ligands that provide the coordination atoms for the binding of the metal ion. As will be appreciated by those in the art, the number and nature of the co-ligands will depend on the coordination number of the metal ion. Mono-, di- or polydentate co-ligands may be used at any position. Thus, for example, when the metal has a coordination number of six, the L from the terminus of the conductive oligomer, the L contributed from the nucleic acid, and r, add up to six. Thus, when the metal has a coordination number of six, r may range from zero (when all coordination atoms are provided by the other two ligands) to four, when all the co-ligands are monodentate. Thus generally, r will be from 0 to 8, depending on the coordination number of the metal ion and the choice of the other ligands.

In one embodiment, the metal ion has a coordination number of six and both the ligand attached to the conductive oligomer and the ligand attached to the nucleic acid are at least bidentate; that is, r is preferably zero, one (i.e. the remaining co-ligand is bidentate) or two (two monodentate co-ligands are used).

As will be appreciated in the art, the co-ligands can be the same or different. Suitable ligands fall into two categories: ligands which use nitrogen, oxygen, sulfur, carbon or phosphorus atoms (depending on the metal ion) as the coordination atoms (generally referred to in the literature as sigma (α) donors) and organometallic ligands such as metallocene ligands (generally referred to in the literature as pi (π) donors, and depicted herein as Lm). Suitable nitrogen donating ligands are well known in the art and include, but are not limited to, cyano (C≡N), NH2; NHR; NRR′; pyridine; pyrazine; isonicotinamide; imidazole; bipyridine and substituted derivatives of bipyridine; terpyridine and substituted derivatives; phenanthrolines, particularly 1,10-phenanthroline (abbreviated phen) and substituted derivatives of phenanthrolines such as 4,7-dimethylphenanthroline and dipyridol[3,2-a:2′,3′-c]phenazine (abbreviated dppz); dipyridophenazine; 1,4,5,8,9,12-hexaazatriphenylene (abbreviated hat); 9,10-phenanthrenequinone diimine (abbreviated phi); 1,4,5,8-tetraazaphenanthrene (abbreviated tap); 1,4,8,11-tetra-azacyclotetradecane (abbreviated cyclam) and isocyanide. Substituted derivatives, including fused derivatives, may also be used. In some embodiments, porphyrins and substituted derivatives of the porphyrin family may be used. See for example, Comprehensive Coordination Chemistry, Ed. Wilkinson et al., Pergammon Press, 1987, Chapters 13.2 (pp 73-98), 21.1 (pp. 813-898) and 21.3 (pp 915-957), all of which are hereby expressly incorporated by reference.

As will be appreciated in the art, any ligand donor (1)-bridge-donor (2) where donor (1) binds to the metal and donor (2) is available for interaction with the surrounding medium (solvent, protein, mediator, etc.) can be used in the present invention, especially if donor (1) and donor (2) are coupled through a pi system, as in cyanos (C is donor (1), N is donor (2), pi system is the CN triple bond). One example is bipyrimidine, which looks much like bipyridine but has N donors on the “back side” for interactions with the medium. Additional co-ligands include, but are not limited to cyanates, isocyanates (—N═C═O), thiocyanates, isonitrile, N₂, O₂, carbonyl, halides, alkoxyide, thiolates, amides, phosphides, and sulfur containing compound such as sulfino, sulfonyl, sulfoamino, and sulfamoyl.

In some embodiments, multiple cyanos are used as co-ligand to complex with different metals. For example, seven cyanos bind Re(III); eight bind Mo(IV) and W(IV). Thus at Re(III) with 6 or less cyanos and one or more L, or Mo(IV) or W(IV) with 7 or less cyanos and one or more L can be used in the present invention. The EAM with W(IV) system has particular advantages over the others because it is more inert, easier to prepare, and has a more favorable reduction potential.

Suitable sigma donating ligands using carbon, oxygen, sulfur and phosphorus are known in the art. For example, suitable sigma carbon donors are found in Cotton and Wilkenson, Advanced Organic Chemistry, 5th Edition, John Wiley & Sons, 1988, hereby incorporated by reference; see page 38, for example. Similarly, suitable oxygen ligands include crown ethers, water and others known in the art. Phosphines and substituted phosphines are also suitable; see page 38 of Cotton and Wilkenson.

The oxygen, sulfur, phosphorus and nitrogen-donating ligands are attached in such a manner as to allow the heteroatoms to serve as coordination atoms.

In some embodiments, organometallic ligands are used. In addition to purely organic compounds for use as redox moieties, and various transition metal coordination complexes with δ-bonded organic ligand with donor atoms as heterocyclic or exocyclic substituents, there is available a wide variety of transition metal organometallic compounds with .pi.-bonded organic ligands (see Advanced Inorganic Chemistry, 5th Ed., Cotton & Wilkinson, John Wiley & Sons, 1988, chapter 26; Organometallics, A Concise Introduction, Elschenbroich et al., 2nd Ed., 1992, VCH; and Comprehensive Organometallic Chemistry II, A Review of the Literature 1982-1994, Abel et al. Ed., Vol. 7, chapters 7, 8, 10 & 11, Pergamon Press, hereby expressly incorporated by reference). Such organometallic ligands include cyclic aromatic compounds such as the cyclopentadienide ion [C5H5 (−1)] and various ring substituted and ring fused derivatives, such as the indenylide (−1) ion, that yield a class of bis(cyclopentadieyl) metal compounds, (i.e. the metallocenes); see for example Robins et al., J. Am. Chem. Soc. 104:1882-1893 (1982); and Gassman et al., J. Am. Chem. Soc. 108:4228-4229 (1986), incorporated by reference. Of these, ferrocene [(C₅H₅)₂ Fe] and its derivatives are prototypical examples which have been used in a wide variety of chemical (Connelly et al., Chem. Rev. 96:877-910 (1996), incorporated by reference) and electrochemical (Geiger et al., Advances in Organometallic Chemistry 23:1-93; and Geiger et al., Advances in Organometallic Chemistry 24:87, incorporated by reference) electron transfer or “redox” reactions. Metallocene derivatives of a variety of the first, second and third row transition metals are potential candidates as redox moieties that are covalently attached to either the ribose ring or the nucleoside base of nucleic acid. Other potentially suitable organometallic ligands include cyclic arenes such as benzene, to yield bis(arene) metal compounds and their ring substituted and ring fused derivatives, of which bis(benzene)chromium is a prototypical example. Other acyclic n-bonded ligands such as the allyl(−1) ion, or butadiene yield potentially suitable organometallic compounds, and all such ligands, in conduction with other .pi.-bonded and .delta.-bonded ligands constitute the general class of organometallic compounds in which there is a metal to carbon bond. Electrochemical studies of various dimers and oligomers of such compounds with bridging organic ligands, and additional non-bridging ligands, as well as with and without metal-metal bonds are potential candidate redox moieties.

When one or more of the co-ligands is an organometallic ligand, the ligand is generally attached via one of the carbon atoms of the organometallic ligand, although attachment may be via other atoms for heterocyclic ligands. Preferred organometallic ligands include metallocene ligands, including substituted derivatives and the metalloceneophanes (see page 1174 of Cotton and Wilkenson, supra). For example, derivatives of metallocene ligands such as methylcyclopentadienyl, with multiple methyl groups being preferred, such as pentamethylcyclopentadienyl, can be used to increase the stability of the metallocene. In a preferred embodiment, only one of the two metallocene ligands of a metallocene are derivatized.

As described herein, any combination of ligands may be used. Preferred combinations include: a) all ligands are nitrogen donating ligands; b) all ligands are organometallic ligands; and c) the ligand at the terminus of the conductive oligomer is a metallocene ligand and the ligand provided by the nucleic acid is a nitrogen donating ligand, with the other ligands, if needed, are either nitrogen donating ligands or metallocene ligands, or a mixture.

As a general rule, EAM comprising non-macrocyclic chelators are bound to metal ions to form non-macrocyclic chelate compounds, since the presence of the metal allows for multiple proligands to bind together to give multiple oxidation states.

In some embodiments, nitrogen donating proligands are used. Suitable nitrogen donating proligands are well known in the art and include, but are not limited to, NH2; NHR; NRR′; pyridine; pyrazine; isonicotinamide; imidazole; bipyridine and substituted derivatives of bipyridine; terpyridine and substituted derivatives; phenanthrolines, particularly 1,10-phenanthroline (abbreviated phen) and substituted derivatives of phenanthrolines such as 4,7-dimethylphenanthroline and dipyridol[3,2-a:2′,3′-c]phenazine (abbreviated dppz); dipyridophenazine; 1,4,5,8,9,12-hexaazatriphenylene (abbreviated hat); 9,10-phenanthrenequinone diimine (abbreviated phi); 1,4,5,8-tetraazaphenanthrene (abbreviated tap); 1,4,8,11-tetra-azacyclotetradecane (abbreviated cyclam) and isocyanide. Substituted derivatives, including fused derivatives, may also be used. It should be noted that macrocylic ligands that do not coordinatively saturate the metal ion, and which require the addition of another proligand, are considered non-macrocyclic for this purpose. As will be appreciated by those in the art, it is possible to covalently attach a number of “non-macrocyclic” ligands to form a coordinatively saturated compound, but that is lacking a cyclic skeleton.

In some embodiments, a mixture of monodentate (e.g., at least one cyano ligand), bidentate, tri-dentate, and polydentate ligands can be used in the construction of EAMs.

Of particular use in the present invention are EAMs that are metallocenes, and in particular ferrocenes, which have at least a first self-immolative moiety attached, although in some embodiments, more than one self-immolative moiety is attached as is described below (it should also be noted that other EAMs, as are broadly described herein, with self-immolative moieties can also be used). In some embodiments, when more than one self-immolative moiety is attached to a ferrocene, they are all attached to one of the cyclopentydienyl rings. In some embodiments, the self-immolative moieties are attached to different rings. In some embodiments, it is possible to saturate one or both of the cyclopentydienyl rings with self-immolative moieties, as long as one site is used for attachment to the electrode.

In some embodiments, the EAMs comprise substituted 1,1′-ferrocenes. Ferrocene is air-stable. It can be easily substituted with both capture ligand and anchoring group. Upon binding of the target protein to the capture ligand on the ferrocene which will not only change the environment around the ferrocene, but also prevent the cyclopentadienyl rings from spinning, which will change the energy by approximately 4 kJ/mol. WO/1998/57159; Heinze and Schlenker, Eur. J. Inorg. Chem. 2974-2988 (2004); Heinze and Schlenker, Eur. J. Inorg. Chem. 66-71 (2005); and Holleman-Wiberg, Inorganic Chemistry, Academic Press 34th Ed, at 1620, all incorporated by reference.

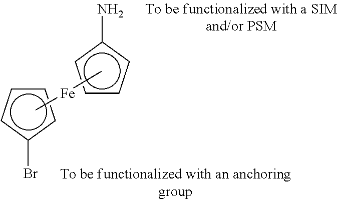

In some other embodiments, the EAMs comprise 1,3-disubstituted ferrocenes. While 1,3-disubstituted ferrocenes are known (see, Bickert et al., Organometallics 1984, 3, 654-657; Farrington et al., Chem. Commun. 2002, 308-309; Pichon et al., Chem. Commun. 2004, 598-599; and Steurer et al., Organometallics 2007, 26, 3850-3859), electrochemical studies of this class of molecules in SAMs have not been reported in the literature. In contrast to 1,1′-disubstituted ferrocenes where cyclopentadienyl (Cp) ring rotation can place both Cp substituents in an eclipsed conformation, 1,3-disubstituted ferrocene regioisomers provide a molecular architecture that enforces a rigid geometry between these Cp groups. Thus, 1,3-disubstituted ferrocenes that possess an anchoring group, such as an organosulfur group for gold anchoring, and a functional group, such as a self-immolative moiety (SIM), peroxide sensitive moiety (PSM), protein capture ligands, and/or enzyme-reactive moieties are suited for SAM-based electrochemical biosensing applications where the receptor is displayed at the solution/SAM interface with limited degrees of freedom. An example of a 1,3-disubstituted ferrocene for attaching both anchoring and functional group is shown below:

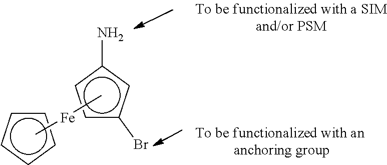

A series of 1,1′- and 1,3-disubstituted ferrocene derivatives (1-5) were synthesized with different functional moieties and organosulfur anchoring groups for SAM formation on gold, and are shown below.

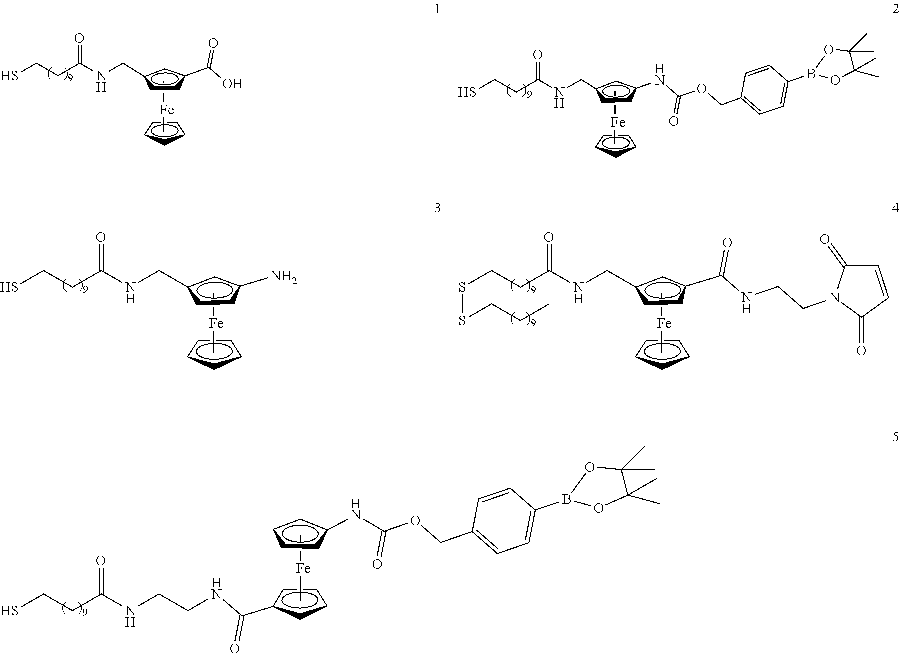

Additional ferrocene EAMs suitable for use in methods of this disclosure are disclosed in U.S. patent application Ser. No. 13/667,713, filed Nov. 2, 2012, which claims the benefit of U.S. Provisional Application No. 61/555,945, filed Nov. 4, 2011, all which are expressly incorporated by reference in their entirety.

In addition, EAMs generally have an attachment moiety for attachment of the EAM to the conductive oligomer which is used to attach the EAM to the electrode. In the case of metallocenes such as ferrocenes, the self-immolative moiety(ies) may be attached to one of the cyclopentydienyl rings, and the attachment moiety may be attached to the other ring, as is generally depicted above, although attachment to the same ring can also be done. As will be appreciated by those in the art, any combination of self-immolative moieties and at least one attachment linker can be used, and on either ring.

In addition to the self-immolative moiety(ies) and the attachment moiety(ies), the ferrocene can comprise additional substituent groups, which can be added for a variety of reasons, including altering the E⁰ in the presence or absence of at least the self-immolative group. Suitable substituent groups, frequently depicted in associated and incorporated references as “R” groups, are recited in U.S. patent application Ser. No. 12/253,828, filed Oct. 17, 2008; U.S. patent application Ser. No. 12/253,875, filed Oct. 17, 2008; U.S. Provisional Patent Application No. 61/332,565, filed May 7, 2010; U.S. Provisional Patent Application No. 61/347,121, filed May 21, 2010; and U.S. Provisional Patent Application No. 61/366,013, filed Jul. 20, 2010, hereby incorporated by reference.

In some embodiments, such as depicted below, the EAM does not comprise a self-immolative moiety, in the case where the peroxide-sensitive moiety is attached directly to the EAM and provides a change in E⁰ when the peroxide-sensitive moiety is exposed to peroxide. As shown below, one embodiment allows the peroxide-sensitive moiety to be attached directly to the EAM (in this case, a ferrocene), such that the ferrocene has a first E⁰ when the pinacol boronate ester moiety is attached, and a second E⁰ when removed, e.g., in the presence of the peroxide.

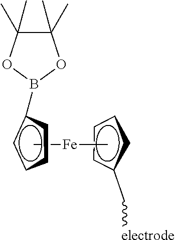

Self-Immolative Moieties

The EAMs of the invention include at least one self-immolative moiety that is covalently attached to the EAM such that the EAM has a first E⁰ when it is present and a second E⁰ when it has been removed as described below.

The term “self-immolative spacer” or “self-immolative moiety” or “SIM” or “self-eliminating group” or grammatical equivalents herein refers to a bifunctional chemical moiety that is capable of covalently linking two chemical moieties into a normally stable tripartate molecule. The self-immolative spacer is capable of spontaneously separating from the second moiety if the bond to the first moiety is cleaved. In the present invention, the self-immolative spacer links a peroxide sensitive moiety (PSM), e.g., a boron moiety, to the EAM. Upon exposure to peroxide, the boron moiety is removed and the spacer falls apart. Generally speaking, any spacer where irreversible repetitive bond rearrangement reactions are initiated by an electron-donating alcohol functional group (i.e. quinone methide motifs) can be designed with boron groups serving as triggering moieties that generate alcohols under oxidative conditions. Alternatively, the boron moiety can mask a latent phenolic oxygen in a ligand that is a pro-chelator for a transition metal. For example, a sample chelating ligand is salicaldehyde isonicotinoyl hydrazone that binds iron.

As will be appreciated by those in the art, a wide variety of self-immolative moieties may be used with a wide variety of EAMs and peroxide sensitive moieties. Self-immolative linkers have been described in a number of references, including US Publication Nos. 20090041791; 20100145036 and U.S. Pat. Nos. 7,705,045 and 7,223,837, all of which are expressly incorporated by reference in their entirety, particularly for the disclosure of self-immolative spacers.

The self-immolative spacer can comprise a single monomeric unit or polymers, either of the same monomers (homopolymers) or of different monomers (heteropolymers). Alternatively, the self-immolative spacer can be a neighboring group to an EAM in a SAM that changes the environment of the EAM following cleavage analogous to the chemistry as recited in previous application “Electrochemical Assay for the Detection of Enzymes”, U.S. Ser. No. 12/253,828, PCT/US2008/080363, hereby incorporated by reference.

Peroxide Sensitive Moieties

The self-immolative spacers join the peroxide sensitive moieties (PSMs, sometimes referred to herein as POMs) and the EAMs of the invention. In general, a peroxide sensitive moiety is one containing boron.

For example, molecules 2 and 5 above depict the use of ferrocene derivatives, where the peroxide triggers a change from a benzyl carbamate with a p-substituted pinacol borate ester to an amine. This self-eliminating group has been described previously for generating amine-functionalized florophores in the presence of hydrogen peroxide (Sella, E.; Shabat, D. Self-immolative dendritic probe for the direct detection of triacetone triperoxide. Chem. Commun. 2008, 5701-5703; and Lo, L.-Cl; Chu, C.-Y. Development of highly selective and sensitive probes for hydrogen peroxide. Chem. Commun. 2003, 2728-2729 both of which are incorporated by reference. Other such groups (aryl borate esters and arylboronic acids) are also described in Sella and Lo. In addition, ferrocenylamines are known to exhibit redox behavior at lower potentials (˜150 mV) as compared to their corresponding carbamate derivatives (see Sagi et al., Amperometric Assay for Aldolase Activity; Antibody-Catalyzed Ferrocenylamine Formation. Anal. Chem. 2006, 78, 1459-1461), incorporated by reference herein).

Capture and Soluble Binding Ligands

In some embodiments, capture binding ligands or soluble binding ligands are used. By “binding ligand” or “binding species” or “capture ligand” “capture binding ligand” or “secondary binding ligand” or “soluble binding ligand” or grammatical equivalents herein is meant a compound that is used to probe for the presence of the target analyte and that will bind to the target analyte. In preferred embodiments, binding ligands are chosen which bind preferentially and specifically to the target analyte but not to other components within the sample or assay mixes. In many embodiments described herein, there are at least two binding ligands used per type of target analyte molecule, where the binding ligands bind to independent sites on the target of interest. In many embodiments, the at least two binding ligands comprise a “capture” or “anchor” binding ligand that is attached to a solid support or a solid particle embedded within a solid support, and a secondary soluble binding ligand comprising at least one label that can either generate peroxide or be used as a part of a peroxide generating system. By “soluble binding ligand” herein is meant a binding ligand that is introduced in solution.

As will be appreciated by those in the art, the composition of the binding ligand will depend on the composition of the target analyte. Binding ligands for a wide variety of analytes are known or can be readily found using known techniques. For example, when the analyte is a protein, binding ligands include proteins (particularly including antibodies or fragments thereof (FAbs, etc.)) or small molecules among others.

In general, antibodies are useful as both capture and soluble binding ligands.

In some embodiments, the soluble binding ligand also comprises a peroxide generating moiety such as an enzyme that generates peroxide. As defined herein, the term “peroxide generating system” or “peroxide-generating system” or “enzyme system” or grammatical equivalents means one or more enzymes that directly generates a peroxide from its substrate and/or one or more intermediary enzymes that generates an intermediate, e.g., a cofactor or pre-substrate, for another enzyme that in turn generates a peroxide. In one example, a peroxide generating moiety may be an enzyme that generates peroxide, e.g., “peroxide generating enzyme”. A wide variety of such enzymes are known, including glucose oxidase, acyl CoA oxidases, alcohol oxidases, aldehyde oxidases, etc. A wide variety of suitable oxidase enzymes are known in the art (see any glucose oxidase enzyme classified as EC 1.1.3.4, including, but not limited to, glucose oxidase, D-amino acid oxidase (DAAO) and choline oxidase). Glucose oxidase enzymes from a wide variety of organisms are well known, including bacterial, fungal, and animal (including mammalian), including, but not limited to, Aspergillus species (e.g. A. niger), Penicillium species, Streptomyces species, etc. Also of use are acyl CoA oxidases, classified as EC 1.3.3.6.

By the term “an intermediary enzyme” herein is meant an enzyme that generates a product that is a substrate or a cofactor for another enzyme such as another intermediary enzyme or a peroxide-generating enzyme. For instance, the soluble binding ligand may contain an enzyme, such as alkaline phosphatase (AP), that catalyzes the generation of a necessary cofactor from a phosphorylated precursor for a soluble apo-oxidase enzyme (i.e., FADP converted to FAD which binds to apo-DAAO) which in turn generates peroxide by reaction with substrate. In the example, AP is an intermediary enzyme. This strategy enables cascade amplification of target binding events if the concentrations of apo-enzyme, phosphorylated cofactor, and oxidase enzyme substrate are high with respect to the target and bound soluble binding ligand. As will be appreciated by those in the art, such amplification is also possible with other enzyme systems than the example above.

As defined herein, the term “target specific enzyme” herein is meant an enzyme that reacts specifically with a target analyte, e.g. glycerol kinase is a specific enzyme for ATP. The target analyte is a substrate for the target specific enzyme.

As defined herein, the term “recycling enzyme” herein is meant an enzyme that regenerates or recycles a necessary substrate of another enzyme for re-use, such as an enzyme that generates NADH from NAD+.

In one embodiment, the binding is specific, and the binding ligand is part of a binding pair. By “specifically bind” or “binds specifically” or grammatical equivalents herein is meant that the ligand binds to the analyte, with specificity sufficient to differentiate between the analyte and other components or contaminants of the test sample or assay mixes. By “specific binding pair” herein is meant a complimentary pair of binding ligand and target analyte such as an antibody/antigen and receptor/ligand. The binding should be sufficient to allow the analyte to remain bound to the ligand under the conditions of the assay, including wash steps to remove non-specific binding. In some embodiments, for example in the detection of certain biomolecules, the binding constants of the analyte to the binding ligand will be at least about 10⁻⁴ to 10⁻⁹ M⁻¹, with at least about 10⁻⁵ to 10⁻⁹ being preferred and at least about 10⁻⁷ to 10⁻⁹ M⁻¹ being particularly preferred.

Binding ligands to a wide variety of target analytes are known or can be readily found using known techniques. For example, when the analyte is a single-stranded nucleic acid, the binding ligand is generally a substantially complementary single-stranded nucleic acid. Alternatively, as is generally described in U.S. Pat. Nos. 5,270,163, 5,475,096, 5,567,588, 5,595,877, 5,637,459, 5,683,867, 5,705,337, and related patents, hereby incorporated by reference, nucleic acid “aptamers” can be developed for binding to virtually any target analyte. Similarly the analyte may be a nucleic acid binding protein and the capture binding ligand is either a single-stranded or double-stranded nucleic acid to which the protein can bind; alternatively, the binding ligand may be a nucleic acid binding protein when the analyte is a single or double-stranded nucleic acid. When the analyte is a protein, suitable binding ligands may include proteins (particularly including antibodies or fragments thereof (FAbs, etc.)), small molecules, or aptamers, described above. Preferred binding ligand proteins include antibodies and peptides. As will be appreciated by those in the art, any two molecules that will associate, preferably specifically, may be used, either as the analyte or the binding ligand. Suitable analyte/binding ligand pairs include, but are not limited to, antibodies/antigens, receptors/ligand, proteins/nucleic acids; nucleic acids/nucleic acids, enzymes/substrates and/or inhibitors, carbohydrates (including glycoproteins and glycolipids)/lectins, carbohydrates and other binding partners, proteins/proteins; and protein/small molecules. These may be wild-type or derivative sequences.

The capture binding ligands (e.g. a capture antibody) can be covalently coupled to solid particles (usually through an attachment linker) or bound tightly but not covalently; for example, using biotin/streptavidin reactions (e.g. biotin on the surface of magnetic beads, streptavin-conjugated capture ligand such as an antibody, or vice versa), bound via a nucleic acid reaction (for example, the capture ligand can have a nucleic acid (“Watson”) and the surface can have a complementary nucleic acid (“Crick”), etc. The capture binding ligands can also be bound directly within the matrix of a porous substrate (e.g. a membrane impregnated with a capture antibody).

It should also be noted that the invention described herein can also be used as a sensor for the illicit explosive triacetone triperoxide (TATP).

Anchor Groups

The present invention provides compounds including the EAM (optionally attached to the electrode surface with a conductive oligomer), the SAM, and the passivation agents. Generally, in some embodiments, these moieties are attached to the electrode using an anchor group. By “anchor” or “anchor group” herein is meant a chemical group that attaches the compounds of the invention to an electrode.

As will be appreciated by those in the art, the composition of the anchor group will vary depending on the composition of the surface to which it is attached. In the case of gold electrodes, both pyridinyl anchor groups and thiol based anchor groups find particular use.

The covalent attachment of the conductive oligomer may be accomplished in a variety of ways, depending on the electrode and the conductive oligomer used. Generally, some type of linker is used, as depicted below as “A” in Structure 1, where X is the conductive oligomer, and the hatched surface is the electrode:

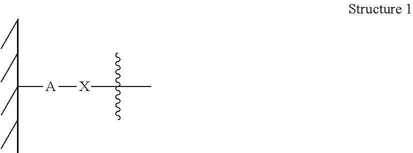

In this embodiment, A is a linker or atom. The choice of “A” will depend in part on the characteristics of the electrode. Thus, for example, A may be a sulfur moiety when a gold electrode is used. Alternatively, when metal oxide electrodes are used, A may be a silicon (silane) moiety attached to the oxygen of the oxide (see for example Chen et al., Langmuir 10:3332-3337 (1994); Lenhard et al., J. Electroanal. Chem. 78:195-201 (1977), both of which are expressly incorporated by reference). When carbon based electrodes are used, A may be an amino moiety, preferably a primary amine (see for example Deinhammer et al., Langmuir 10:1306-1313 (1994)). Thus, preferred A moieties include, but are not limited to, silane moieties, sulfur moieties (including alkyl sulfur moieties), and amino moieties.

In some embodiments, the electrode is a carbon electrode, i.e. a glassy carbon electrode, and attachment may be via a nitrogen of an amine group. A representative structure is depicted in Structure 15 of US Patent Application Publication No. 20080248592, hereby incorporated by reference in its entirety but particularly for Structures as described therein and the description of different anchor groups and the accompanying text. Again, additional atoms may be present, i.e. linkers and/or terminal groups.

In Structure 16 of US Patent Application Publication No. 20080248592, hereby incorporated by reference as above, the oxygen atom is from the oxide of the metal oxide electrode. The Si atom may also contain other atoms, i.e. be a silicon moiety containing substitution groups. Other attachments for SAMs to other electrodes are known in the art; see for example Napier et al., Langmuir, 1997, for attachment to indium tin oxide electrodes, and also the chemisorption of phosphates to an indium tin oxide electrode (talk by H. Holden Thorpe, CHI conference, May 4-5, 1998).

In one preferred embodiment, indium-tin-oxide (ITO) is used as the electrode, and the anchor groups are phosphonate-containing species.

Sulfur Anchor Groups

Although depicted in Structure 1 as a single moiety, the conductive oligomer may be attached to the electrode with more than one “A” moiety; the “A” moieties may be the same or different. Thus, for example, when the electrode is a gold electrode, and “A” is a sulfur atom or moiety, multiple sulfur atoms may be used to attach the conductive oligomer to the electrode, such as is generally depicted below in Structures 2, 3, and 4. As will be appreciated by those in the art, other such structures can be made. In Structures 2, 3, and 4 the A moiety is just a sulfur atom, but substituted sulfur moieties may also be used.

Thus, for example, when the electrode is a gold electrode, and “A” is a sulfur atom or moiety, multiple sulfur atoms may be used to attach the conductive oligomer to the electrode, such as is generally depicted below in Structures 2, 3, and 4. As will be appreciated by those in the art, other such structures can be made. In Structures 2, 3, and 4, the A moiety is just a sulfur atom, but substituted sulfur moieties may also be used.

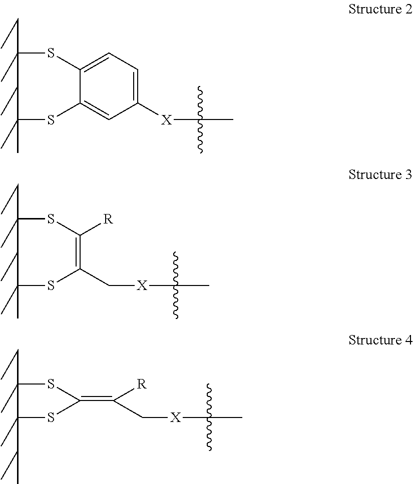

It should also be noted that similar to Structure 4, it may be possible to have a conductive oligomer terminating in a single carbon atom with three sulfur moieties attached to the electrode.

In another aspect, the present invention provides anchors comprising conjugated thiols. In some embodiments, the anchor comprises an alkylthiol group.

In another aspect, the present invention provides conjugated multipodal thio-containing compounds that serve as anchoring groups in the construction of electroactive moieties for analyte detection on electrodes, such as gold electrodes. That is, spacer groups (which can be attached to EAMs, ReAMCs, or an “empty” monolayer forming species) are attached using two or more sulfur atoms. These mulitpodal anchor groups can be linear or cyclic, as described herein.

In some embodiments, the anchor groups are “bipodal”, containing two sulfur atoms that will attach to the gold surface, and linear, although in some cases it can be possible to include systems with other multipodalities (e.g. “tripodal”). Such a multipodal anchoring group may display increased stability and/or allow a greater footprint for preparing SAMs from thiol-containing anchors with sterically demanding headgroups.

In some embodiments, the anchor comprises cyclic disulfides (generally “bipodal” although in some cases it can be possible to include ring system anchor groups with other multipodalities, e.g. “tripodal”). The number of the atoms of the ring can vary, for example from 5 to 10, and also includes multicyclic anchor groups, as discussed below.

In some embodiments, the anchor groups comprise a [1,2,5]-dithiazepane unit which is a seven-membered ring with an apex nitrogen atom and a intramolecular disulfide bond as shown below:

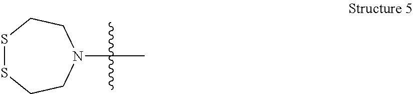 [SMILES: *N1CCSSCC1]

In Structure (5), it should also be noted that the carbon atoms of the ring can additionally be substituted. As will be appreciated by those in the art, other membered rings are also included. In addition, multicyclic ring structures can be used, which can include cyclic heteroalkanes such as the [1,2,5]-dithiazepane shown above substituted with other cyclic alkanes (including cyclic heteroalkanes) or aromatic ring structures.

In some embodiments, the anchor group and part of the spacer has the structure shown below

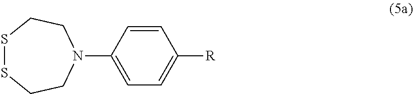

The “R” group herein can be any substitution group, including a conjugated oligophenylethynylene unit with terminal coordinating ligand for the transition metal component of the EAM.

The anchors are synthesized from a bipodal intermediate (the compound as formula 5a where R═I), which is described in Li et al., Org. Lett. 4:3631-3634 (2002), herein incorporated by reference. See also Wei et al, J. Org, Chem. 69:1461-1469 (2004), herein incorporated by reference.

The number of sulfur atoms can vary as outlined herein, with particular embodiments utilizing one, two, and three per spacer.

As will be appreciated by those in the art, the compositions of the invention can be made in a variety of ways, including those outlined below and in U.S. patent application Ser. No. 12/253,828, filed Oct. 17, 2008; U.S. patent application Ser. No. 12/253,875, filed Oct. 17, 2008; U.S. Provisional Patent Application No. 61/332,565, filed May 7, 2010; U.S. Provisional Patent Application No. 61/347,121, filed May 21, 2010; U.S. Provisional Patent Application No. 61/366,013, filed Jul. 20, 2010. In some embodiments, the composition are made according to methods disclosed in of U.S. Pat. Nos. 6,013,459, 6,248,229, 7,018,523, 7,267,939, U.S. patent application Ser. Nos. 09/096,593 and 60/980,733, and U.S. Provisional Application No. 61/087,102, filed on Aug. 7, 2008, all are herein incorporated in their entireties for all purposes.

Applications

The systems of the invention find use in the detection of a variety of target analytes, as outlined herein. In particular, the systems of the invention find great use in the detection of multiple target analytes within a sample simultaneously, i.e. when multiplexing is needed. In some embodiments, “sandwich” type assays are used. In other embodiments, for example when targets are enzymes, small molecules, or particular metabolites, other formats are used.

This device can utilize a method of detecting A1c with a single measurement, as described in U.S. patent application Ser. No. 13/653,931, the disclosure of which is incorporated herein by reference. In brief, such a method utilizes one capture ligand that binds all forms of hemoglobin within a sample equally, wherein the total binding capacity is a known quantity and the ratio of glycated hemoglobin, hemoglobin A1c, to total hemoglobin bound to the capture ligands is proportional to the ratio of hemoglobin A1c to total hemoglobin in the sample. Such a method also utilized a secondary binding ligand specific for hemoglobin A1c only, wherein the secondary binding ligand comprises part of a peroxide generating system. Peroxide is generated, reacted with EAM molecules, and signal measured according to any of the methods generally described above, where the signal measured is an indicator of the percent of hemoglobin A1c present in the original sample. The results of the A1c assay can be quantitative or qualitative, with the qualitative result format finding particular use as a yes/no tool for diagnosis of Type II diabetes, comparing the result to a known cutoff.

In some embodiments, assay conditions mimic physiological conditions. Generally a plurality of assay mixtures are run in parallel with different concentrations to obtain a differential response to the various concentrations. That is, a dose response curve is generated. Typically, one of these concentrations serves as a negative control, i.e., at zero concentration or below the level of detection. Once a dose response has been established with known quantities, it can be used to measure unknown quantities in samples. In addition, as will be appreciated by those in the art, any variety of other reagents may be included in the assays. These include reagents like salts, buffers, detergents, neutral proteins, e.g. albumin, etc. which may be used to facilitate optimal binding and/or reduce non-specific or background interactions. Also reagents that otherwise improve the efficiency of the assay, such as protease inhibitors, nuclease inhibitors, anti-microbial agents, etc., may be used. The mixture of components may be added in any order that provides for the requisite binding.

The generation of peroxidase results in the loss of the PSM and SIM components of the EAM complex, resulting a change in the E⁰ of the EAM. In some embodiments, the E⁰ of the EAM changes by at about 20 mV, 30 mV, 40 mV, 50 mV, 75 mV, 80 mV, 90 mV to 100 mV, with some embodiments resulting in changes of 200, 300 or 500 mV being achieved. In some embodiments, the changes in the E⁰ of the EAM is a decrease. In some embodiments, the changes in the E⁰ of the EAM is an increase.

Electron transfer is generally initiated electronically, with voltage being preferred. Precise control and variations in the applied potential can be via a potentiostat and either a three electrode system (one reference, one sample, and one counter electrode) or a two electrode system (one sample and one counter electrode). This allows matching of applied potential to peak electron transfer potential of the system which depends in part on the choice of redox active molecules and in part on the conductive oligomer used.

Detection

Electron transfer between the redox active molecule and the electrode can be detected in a variety of ways, with electronic detection, including, but not limited to, amperommetry, voltammetry, capacitance and impedance being preferred. These methods include time or frequency dependent methods based on AC or DC currents, pulsed methods, lock in techniques, and filtering (high pass, low pass, band pass). In some embodiments, all that is required is electron transfer detection; in others, the rate of electron transfer may be determined.

In some embodiments, electronic detection is used, including amperommetry, voltammetry, capacitance, and impedance. Suitable techniques include, but are not limited to, electrogravimetry; coulometry (including controlled potential coulometry and constant current coulometry); voltametry (cyclic voltametry, pulse voltametry (normal pulse voltametry, square wave voltametry, differential pulse voltametry, Osteryoung square wave voltametry, and coulostatic pulse techniques)); stripping analysis (aniodic stripping analysis, cathiodic stripping analysis, square wave stripping voltammetry); conductance measurements (electrolytic conductance, direct analysis); time dependent electrochemical analyses (chronoamperometry, chronopotentiometry, cyclic chronopotentiometry and amperometry, AC polography, chronogalvametry, and chronocoulometry); AC impedance measurement; capacitance measurement; AC voltametry, and photoelectrochemistry.

In some embodiments, monitoring electron transfer is via amperometric detection. This method of detection involves applying a potential (as compared to a separate reference electrode) between the electrode containing the compositions of the invention and an auxiliary (counter) electrode in the test sample. Electron transfer of differing efficiencies is induced in samples in the presence or absence of target analyte.

The device for measuring electron transfer amperometrically involves sensitive current detection and includes a means of controlling the voltage potential, usually a potentiostat. This voltage is optimized with reference to the potential of the redox active molecule.

In some embodiments, alternative electron detection modes are utilized. For example, potentiometric (or voltammetric) measurements involve non faradaic (no net current flow) processes and are utilized traditionally in pH and other ion detectors. Similar sensors are used to monitor electron transfer between the redox active molecules and the electrode. In addition, other properties of insulators (such as resistance) and of conductors (such as conductivity, impedance and capicitance) could be used to monitor electron transfer between the redox active molecules and the electrode. Finally, any system that generates a current (such as electron transfer) also generates a small magnetic field, which may be monitored in some embodiments.

It should be understood that one benefit of the fast rates of electron transfer observed in the compositions of the invention is that time resolution can greatly enhance the signal to noise results of monitors based on electronic current. The fast rates of electron transfer of the present invention result both in high signals and stereotyped delays between electron transfer initiation and completion. By amplifying signals of particular delays, such as through the use of pulsed initiation of electron transfer and “lock in” amplifiers of detection, orders of magnitude improvements in signal to noise may be achieved.

In some embodiments, electron transfer is initiated and detected using direct current (DC) techniques. As noted above, the first E⁰ of the unreacted redox active molecule before and the second E⁰ of the reacted redox active molecule afterwards will allow the detection of the analyte. As will be appreciated by those in the art, a number of suitable methods may be used to detect the electron transfer.

In some embodiments, electron transfer is initiated using alternating current (AC) methods. A first input electrical signal is applied to the system, preferably via at least the sample electrode (containing the complexes of the invention) and the counter electrode, to initiate electron transfer between the electrode and the second electron transfer moiety. Three electrode systems may also be used, with the voltage applied to the reference and working electrodes. In this embodiment, the first input signal comprises at least an AC component. The AC component may be of variable amplitude and frequency. Generally, for use in the present methods, the AC amplitude ranges from about 1 mV to about 1.1 V, with from about 10 mV to about 800 mV being preferred, and from about 10 mV to about 500 mV being especially preferred. The AC frequency ranges from about 0.01 Hz to about 10 MHz, with from about 1 Hz to about 1 MHz being preferred, and from about 1 Hz to about 100 kHz being especially preferred

In some embodiments, the first input signal comprises a DC component and an AC component. That is, a DC offset voltage between the sample and counter electrodes is swept through the electrochemical potential of the second electron transfer moiety. The sweep is used to identify the DC voltage at which the maximum response of the system is seen. This is generally at or about the electrochemical potential of the redox active molecule. Once this voltage is determined, either a sweep or one or more uniform DC offset voltages may be used. DC offset voltages of from about 1 V to about +1.1 V are preferred, with from about 500 mV to about +800 mV being especially preferred, and from about 300 mV to about 500 mV being particularly preferred. On top of the DC offset voltage, an AC signal component of variable amplitude and frequency is applied. If the redox active molecule has a low enough solvent reorganization energy to respond to the AC perturbation, an AC current will be produced due to electron transfer between the electrode and the redox active molecule.

In some embodiments, the AC amplitude is varied. Without being bound by theory, it appears that increasing the amplitude increases the driving force. Thus, higher amplitudes, which result in higher overpotentials give faster rates of electron transfer. Thus, generally, the same system gives an improved response (i.e. higher output signals) at any single frequency through the use of higher overpotentials at that frequency. Thus, the amplitude may be increased at high frequencies to increase the rate of electron transfer through the system, resulting in greater sensitivity. In addition, as noted above, it may be possible to detect the first and second E⁰ of the redox active molecules on the basis of the rate of electron transfer, which in turn can be used either to distinguish the two on the basis of frequency or overpotential.

In some embodiments, measurements of the system are taken at least two separate amplitudes or overpotentials, with measurements at a plurality of amplitudes being preferred. As noted above, changes in response as a result of changes in amplitude may form the basis of identification, calibration and quantification of the system.

In some embodiments, the AC frequency is varied. At different frequencies, different molecules respond in different ways. As will be appreciated by those in the art, increasing the frequency generally increases the output current. However, when the frequency is greater than the rate at which electrons may travel between the electrode and the redox active molecules, higher frequencies result in a loss or decrease of output signal. At some point, the frequency will be greater than the rate of electron transfer through even solvent inhibited redox active molecules, and then the output signal will also drop.

In addition, the use of AC techniques allows the significant reduction of background signals at any single frequency due to entities other than the covalently attached nucleic acids, i.e. “locking out” or “filtering” unwanted signals. That is, the frequency response of a charge carrier or redox active molecule in solution will be limited by its diffusion coefficient. Accordingly, at high frequencies, a charge carrier may not diffuse rapidly enough to transfer its charge to the electrode, and/or the charge transfer kinetics may not be fast enough. This is particularly significant in embodiments that do not utilize a passavation layer monolayer or have partial or insufficient monolayers, i.e. where the solvent is accessible to the electrode. As outlined above, in DC techniques, the presence of “holes” where the electrode is accessible to the solvent can result in solvent charge carriers “short circuiting” the system. However, using the present AC techniques, one or more frequencies can be chosen that prevent a frequency response of one or more charge carriers in solution, whether or not a monolayer is present. This is particularly significant since many biological fluids such as blood contain significant amounts of redox active molecules which can interfere with amperometric detection methods.

In some embodiments, measurements of the system are taken at least two separate frequencies, with measurements at a plurality of frequencies being preferred. A plurality of frequencies includes a scan. In a preferred embodiment, the frequency response is determined at at least two, preferably at least about five, and more preferably at least about ten frequencies.

Signal Processing

After transmitting the input signal to initiate electron transfer, an output signal is received or detected. The presence and magnitude of the output signal will depend on the overpotential/amplitude of the input signal, the frequency of the input AC signal, the composition of the intervening medium, i.e. the impedance, between the electron transfer moieties, the DC offset, the environment of the system, and the solvent. At a given input signal, the presence and magnitude of the output signal will depend in general on the solvent reorganization energy required to bring about a change in the oxidation state of the metal ion. Thus, upon transmitting the input signal, comprising an AC component and a DC offset, electrons are transferred between the electrode and the redox active molecule, when the solvent reorganization energy is low enough, the frequency is in range, and the amplitude is sufficient, resulting in an output signal.

In some embodiments, the output signal comprises an AC current. As outlined above, the magnitude of the output current will depend on a number of parameters. By varying these parameters, the system may be optimized in a number of ways.

In general, AC currents generated in the present invention range from about 1 femptoamp to about 1 milliamp, with currents from about 50 femptoamps to about 100 microamps being preferred, and from about 1 picoamp to about 1 microamp being especially preferred.

Apparatus

The present invention further provides apparatus for the detection of analytes using AC detection methods. The apparatus includes a test chamber which has at least a first measuring or sample electrode, and a second measuring or counter electrode. Three electrode systems are also useful. The first and second measuring electrodes are in contact with a test sample receiving region, such that in the presence of a liquid test sample, the two electrodes may be in electrical contact.

In yet another embodiment, the first measuring electrode comprises a redox active complex, covalently attached via a spacer, and preferably via a conductive oligomer, such as are described herein. Alternatively, the first measuring electrode comprises covalently attached redox active molecules.

The apparatus further comprises a voltage source electrically connected to the test chamber; that is, to the measuring electrodes. Preferably, the voltage source is capable of delivering AC and DC voltages, if needed.

In an embodiment, the apparatus further comprises a processor capable of comparing the input signal and the output signal. The processor is coupled to the electrodes and configured to receive an output signal, and thus detect the presence of the target analyte.

Devices

The methods described herein have broad application. Several types of devices, however find particular use with the methods presented herein. Some example devices are described, though it should be understood that these are intended to be non-limiting examples.

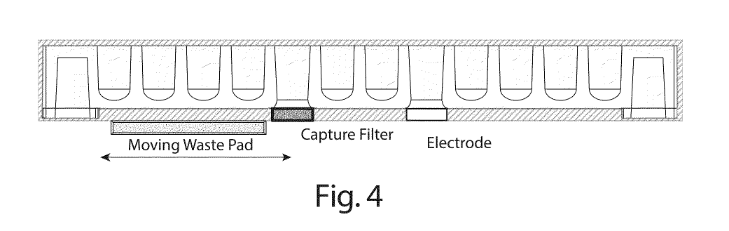

One example of a device that finds particular use with the methods described herein is a device designed as a strip of wells for use with a standard liquid handling device. See FIG. 4. Such a device may have overall dimensions and well dimensions compatible with the particular liquid handling device chosen. The wells may contain all necessary assay components, stored in such a way as to prevent any reaction from occurring prior to use. At least one well of the device has a bottom modified with a porous substrate (e.g., a flow-through membrane). The porous substrate may also contain immobilized target specific detection components. At least one other well of the device has a bottom modified with a surface that can act as an electrode, and may include pieces extending beyond the edges of the well or main body of the device to allow connection to an apparatus for reading the electrode. Sample is added and assay components are taken from each well and added to the well containing the modified porous substrate in such an order as to perform an assay. The device may also contain a waste container underneath to collect material as it flows through the solid support. It may also contain a wicking waste pad to facilitate movement of fluids through the porous substrate. Once all assay steps have been completed, the final assay mixture is added to the well modified with the electrode, and signal is measured using an appropriate apparatus.

FIG. 4 depicts one type of device that allows the certain inventive methods to be applied to standard immunoassays. When used in conjunction with a liquid handling device (automated or manual), assay components stored in the wells pictured can be moved through the modified capture filter sequentially to perform the assay. In a standard sandwich immunoassay, target is immobilized in the capture filter while waste and unbound assay components are allowed to filter through and/or are washed through to the waste pad below. Once the final assay mixture has been produced, it can be transferred to the electrode for reading.

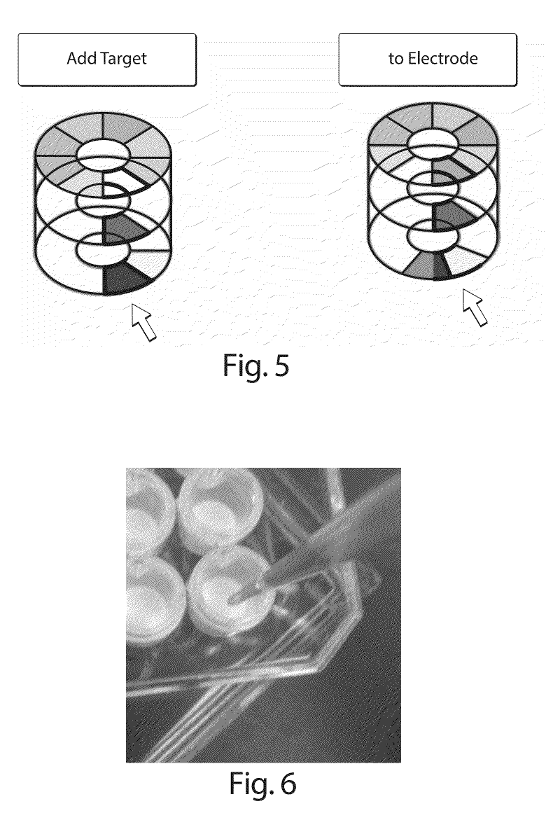

Another example of a device that finds particular use with the methods described herein is a cartridge that contains reagents specific for detecting the target analyte in a sample, has distinct regions and layers, may include porous substrates to immobilize dry reagents or liquid reagents, and also incorporates an electrode for detection. See FIG. 5. The cartridge is designed such that user actions are minimized and controlled such that the potential for errors is small. In some embodiments, the method only requires the user to rotate layers of a cartridge, and in some embodiments, the user may be required to add a sample and load a solution onto the device chamber.

In some embodiments, the cartridge may comprise two or more layers (e.g., three layers, four layers). For instance, the cartridge may comprise three circular layers each separated into individual chambers. Gaps in the layers may allow fluid to travel between layers directly or through membranes. In some embodiments, a method of operation may comprise a user rotating the layers of the cartridge relative to one another at prescribed times to execute the steps of the assay. In certain embodiments, a user may add solution to a portion of a layer (e.g., chamber) to resuspend a dried reagent prior to rotating the top layer. In other embodiments, the rotation may break a seal and release a liquid reagent contained in a particular chamber. This rotational action may align the target chamber with a flow-through region on the layer below allowing movement of reagents. This process may be repeated by rotating the top cartridge layer again, introducing the next reagent to the designated region below.

The bottom layer may have a waste region that allows capillary forces to provide continuous flow across a membrane on the middle layer. Capillary forces would move the reagent from the top layer, through the membrane on the middle layer and into the chamber on the bottom later. In some instances, the bottom layer may also comprise regions that to block the flow of fluid across the middle layer. This solid bottom region may allow a reagent solution from the top layer to incubate on the membrane in the middle layer region. The bottom layer may comprise a region containing an electrode for detection.

FIG. 5 depicts a multi-level rotating cartridge incorporating a filter membrane as part of a novel stand-alone device for simplifying assay procedures. Rotating the top layer allows different assay components to flow through the membrane. Rotating the middle or bottom cartridge controls the flow by emptying to a waste compartment, emptying to an electrode for final reading, or providing a stopper to prevent flow through the membrane. FIG. 5A depicts an example of the cartridge, while FIG. 5B shows a more detailed breakdown of what each layer may contain.

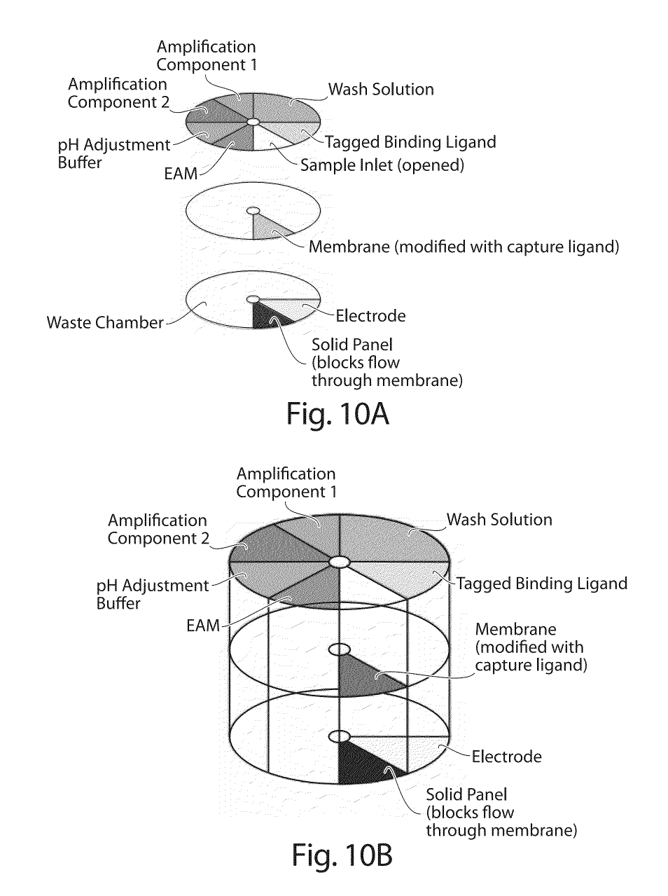

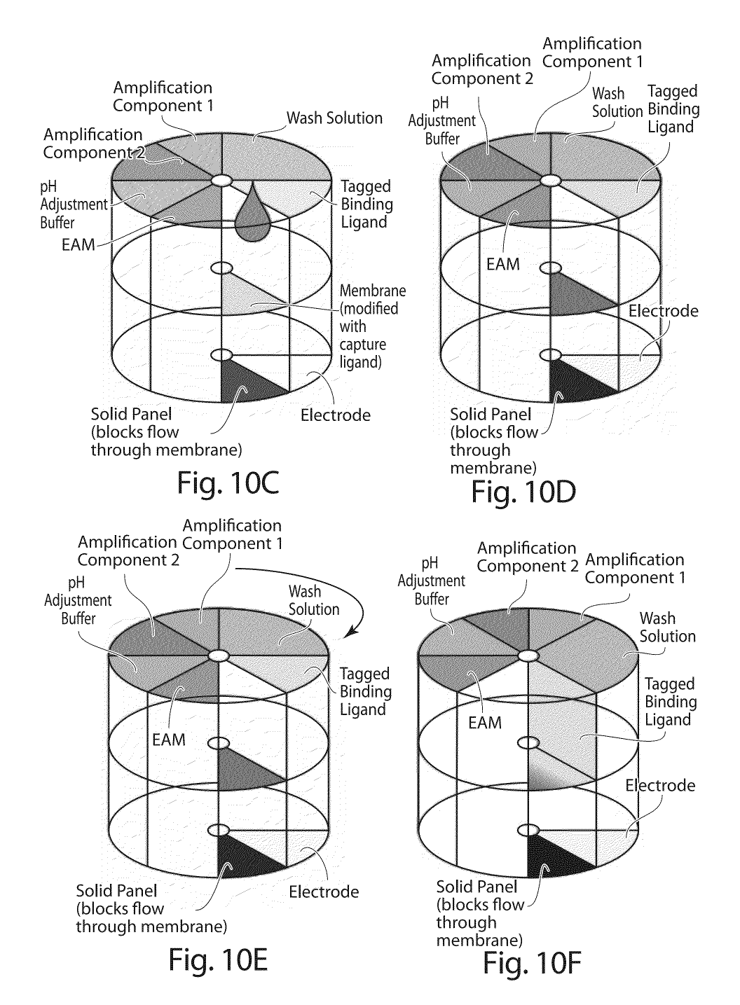

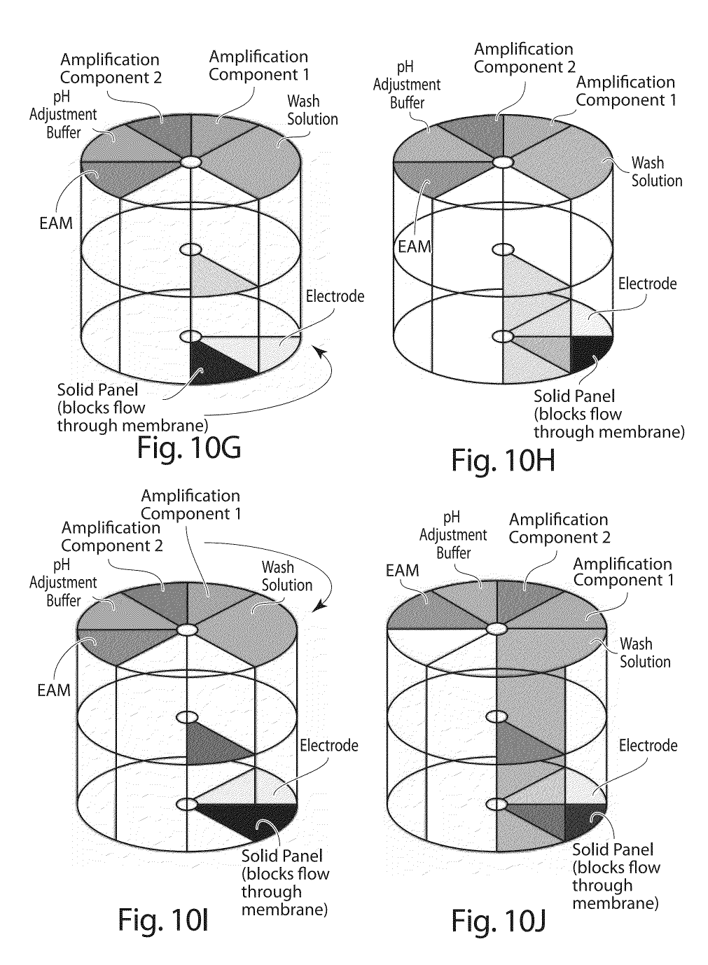

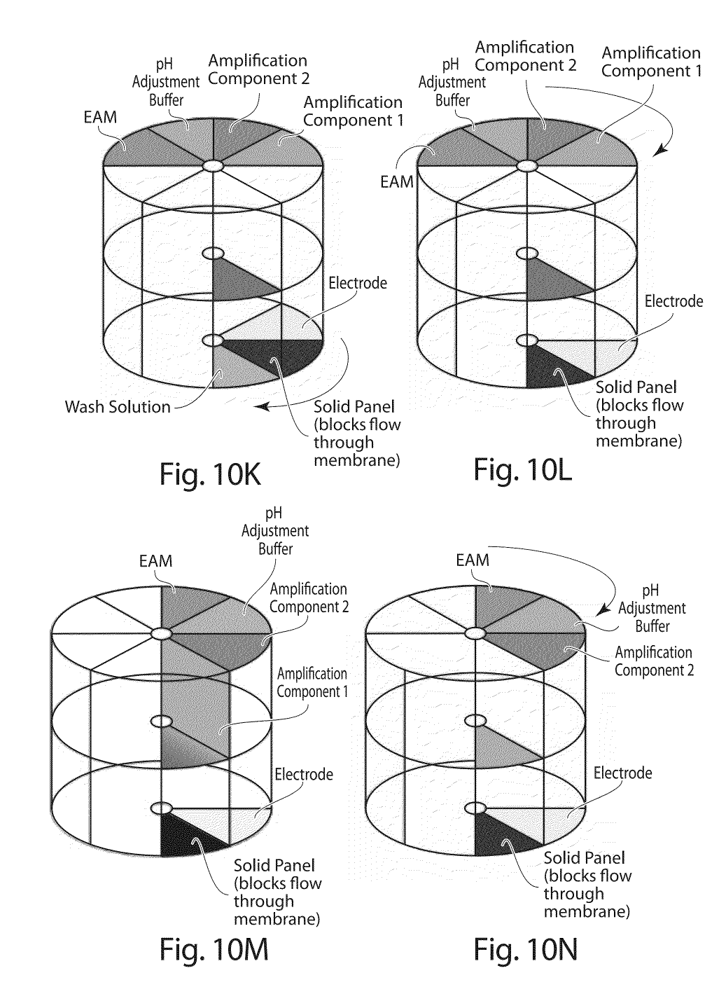

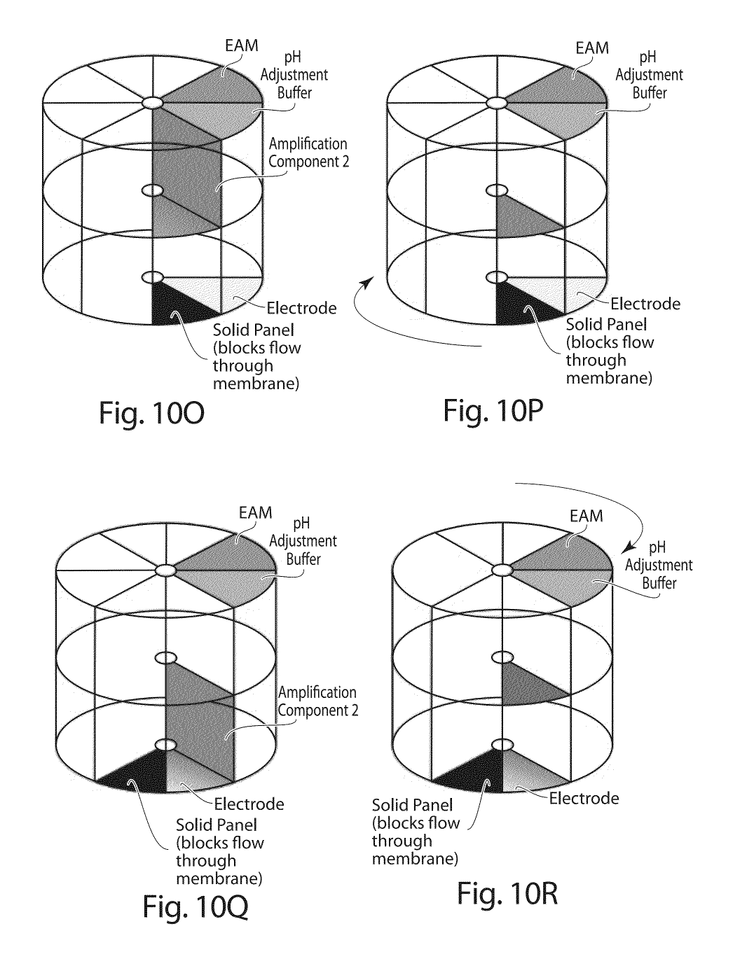

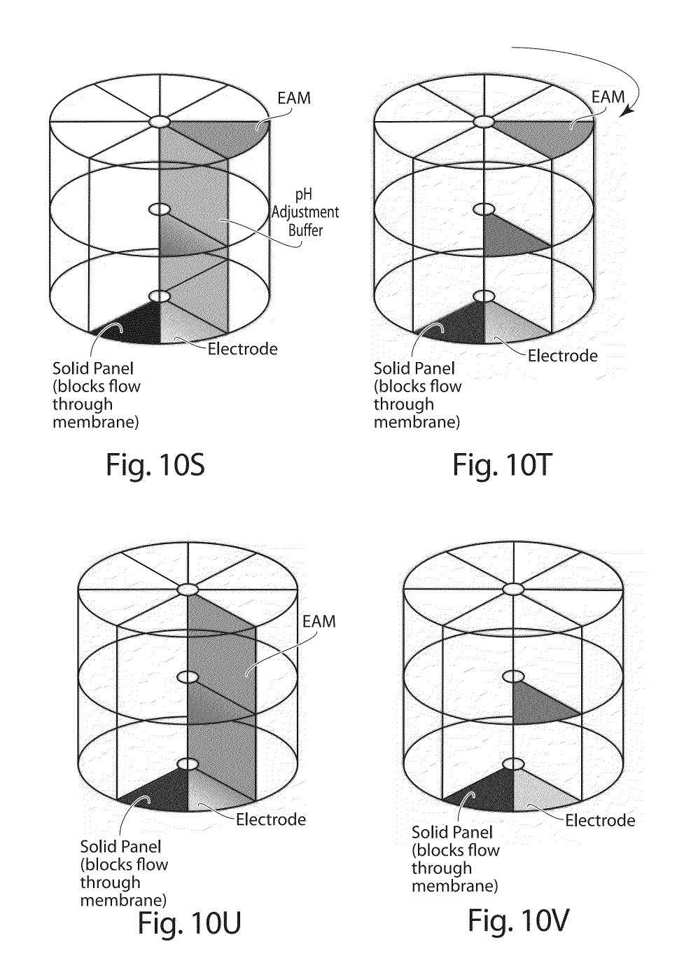

It should be understood that though the layers in the cartridge are illustrated as circular or substantially circular in FIG. 5 and FIGS. 10A-V, the layers may have any suitable shape.

Assay for Analyte Detection with a Rotating Cartridge

In some embodiments, a cartridge may comprise three layers (e.g., substantially circular layers) that each have multiple regions physically separated from one another, creating independent chambers as shown in FIG. 10A. The layers may have varying thickness dependent on the function and volume required for each particular chamber.

The layers may be adjoined such that when rotated relative to each other, one or more regions from a layer will be exposed to a region of another layer, as shown in FIG. 10B. In some embodiments, one or more (e.g., each) layers may contain regions that serve to generate flow through capillary forces by containing a porous substrate (e.g., membrane) or other material. Reagents necessary for performing an assay may be contained within the cartridge.

A non-limiting example of cartridge layout is depicted in FIG. 5 and FIG. 10B. In some embodiments, the top layer may comprise chambers that contain liquid or dry reagents necessary to perform an assay. In certain embodiments, dry reagents may be resuspended by the user prior to adding the sample and executing the test. In some embodiments, the sample is introduced into cartridge and is delivered to a porous substrate in the middle layer, as depicted in FIG. 10C and FIG. 10D. The target, if present in the sample, may become bound via a biological binding event with a capture ligand (e.g., antibody) to the porous substrate. This porous substrate could contain solid particles such as beads modified with the capture ligands, the capture ligands could be bound to the porous substrate itself, or other methods. In one example, the porous substrate may comprise an enzyme tagged binding ligand (e.g., enzyme tagged probe antibody) in addition to the capture ligand. In other examples, an enzyme tagged binding ligand (e.g., enzyme tagged probe antibody) may be in a separate compartment of the top layer. In some such embodiments, the top layer can be rotated relative to the middle and bottom layers to allow the enzyme tagged binding ligand to reach the porous support of the middle layer, containing the bound target, as depicted in FIG. 10E and FIG. 10F. At this point, in certain embodiments, the porous substrate in the middle layer may be sealed on the bottom by a region (i.e., blocking region) of the bottom layer. The bottom layer of the cartridge may then be rotated relative to the middle and top layers aligning the membrane region of the middle layer with the capillary force/waste region of the bottom layer, as depicted in FIG. 10G, and the solution added to the cartridge may be allowed to drain to waste, as depicted in FIG. 10H. In some embodiments, the top layer of the cartridge is then rotated relative to the middle and bottom layers and a region containing a wash solution is aligned with the membrane region of the middle layer, as shown in FIG. 10I and FIG. 10J. In other instances, the top layer may have an empty region allowing the user to add wash solution to the membrane in the middle layer. For either wash method, flow is generated from gravity and capillary forces, driving the wash solution across the porous substrate in the middle layer containing immobilized target, into the waste region of the bottom layer. This wash may serve to remove any unbound, tagged probe antibody.

Once no fluid remains above the middle layer membrane, the bottom layer may then be rotated relative to the middle layer so that the porous substrate in the middle layer aligns with the closed region, preventing further flow across the membrane, as depicted in FIG. 10K. The top layer may be rotated relative to the middle and bottom layers releasing a solution containing an amplification reagent or other reagents onto the porous substrate. This may be repeated until all necessary amplification components have been added. These steps are generally depicted in FIG. 10L-FIG. 10O. Solution incubates on membrane for a designated amount of time.

In some embodiments, the bottom layer may be rotated relative to the middle and top layers exposing the region containing the electrode to the porous substrate, as depicted in FIG. 10P. Solution may then flow across the membrane in the middle layer into the chamber containing the electrode, as depicted in FIG. 10Q. The bottom layer chamber that comprises the electrode may also comprise a reagent for adjusting pH and may have a membrane to generate flow. In other instances, a reagent for adjusting pH may be contained in the top layer, and the top layer may be rotated relative to the middle and bottom layers to add the reagent, as depicted in FIG. 10R-FIG. 10S. In some embodiments, the EAM may be stored in the top layer, and the top layer may be rotated relative to the middle and bottom layers to add the EAM to the electrode. In certain instances, the EAM may be stored with the electrode directly, i.e., the electrode of the bottom layer may have a preformed SAM comprising EAM molecules.

In some embodiments, the top layer may then be rotated, again, relative to the middle and bottom layers, as depicted in FIG. 10T, releasing the detection solution. The detection solution may then flow through the middle layer membrane, into the bottom layer chamber containing the electrode, as depicted in FIG. 10U. FIG. 10V generally depicts the signal measurement. The electrode may be interrogated by a reader apparatus. The signal output measured by the reader may be related to the amount of target present in the test sample. For hemoglobin A1c, the single signal output measured by the reader is translated directly into percentage of total hemoglobin that is hemoglobin A1c in the test sample. The signal may also be translated directly into a ‘yes/no’ or ‘above/below’ answer to indicate whether the percentage of A1c in the sample is above or below a cutoff value, to aid in diagnosis of Type II diabetes.

Given the alternatives noted above, it should be understood that the conformation of the cartridge may change as assay reagents are adjusted. As will be appreciated by those in the art, steps as described above may also change accordingly.

User Adding Solution

For the methods where a user adds solution to the chambers in the top layer of the cartridge, the cartridge may be designed such that the user cannot overfill the chambers. The top of the cartridge will have two holes in the top of each chamber, the smaller of which is for venting. The user may add solution on top of the larger hole of each chamber until it is full and fluid forms a droplet on top of cartridge instead of filling the chamber further. The user may then wipes away remaining droplets on top of the cartridge, if applicable. This may prevent the user from overfilling the chamber and losing reagents. Excess dilution of reagents from diffusion into the droplet outside of the chamber will be minimal.

### EXAMPLES

### Example 1

### Purpose

To evaluate the performance of an A1c assay with beads immobilized within a filter. Time for enzymatic system amplification was varied.

I. Prepare Stocks
a. Prepare 1500 uL Binding Buffer with appropriate detergent
i.
b. Prepare dilutions of target and clinical samples:

| Bio-Rad | [symbol] |
|---|---|
| Label | A1c |
| Level 1 | [symbol] .7% |
| Level 2 | [symbol] .2% |
| Level 3 | [symbol] .8% |

Note:
Bio-Rad calibrants are manufactured to have a “linear relationship.”
Alc % are taken from Bio-Rad D-10 A1c Dual Program Reorder Pack 220-0201 (NGSP) Target Alc % values [symbol]
indicates data missing or illegible when filed

i. Make 3% dilution: (100 uL): 3 uL of 100% sample+97 uL of Binding Buffer w/4.4% detergent
c. Pre-mix 80 ng/uL secondary antibody and 80 ng/uL IgG-AP complex (252 uL):
i. 6.11 uL of anti-A1c stock
ii. 33.6 uL of anti-mouse-IgG-AP
iii. 212 uL of Binding Buffer
iv. Pre-mix for 30 min+
d. Prepare beads
i. Magnetic beads with capture antibody are pre-washed and pre-blocked. Vortex bead stocks to mix thoroughly.
ii. Create bead solution (200 uL):
1. 2 ug/uL=40 uL of 10 ug/uL GTX bead stock (Jul. 23, 2013; Lot 33164)+160 uL of Binding Buffer
e. Prepare amplification stocks including DAAO, FADP, D-proline, buffer:
f. Prepare EAM solutions

II. Sandwich Formation and Washing Beads
a. Prior to beginning the timed portion of the assay, load 15 uL of bead suspension [30 ug] onto center of filter at the bottom of 96-well filter microplate (see FIG. 6 for example of filter plate).
b. Add 20 uL of target to 20 uL of AP complex. Incubate.
c. Add this 40 uL solution to appropriate microplate well. Incubate.
d. After incubation, apply an absorbent material, e.g. paper towel, under the appropriate well, wicking away the liquid by drawing it though the filter at the bottom of the plate.
e. Wash well with 100 uL wash buffer three times and 100 uL Tris three times, wicking away liquid from bottom each time.

III. Substrate Addition and Enzyme Amplification
a. Add 20 uL of FADP to 20 uL of previously aliquotted DAAO solution
b. Add this to appropriate well and incubate for appropriate time (45 seconds, 60 seconds, 90 seconds).
c. After incubation, draw 30 uL from this solution and adjust pH.

IV. Solution-SAM Testing
a. Prepare 6-well chips
b. After peroxide generation, add 30 uL from the pHed solution into 20 uL of EAM solution. Incubate.
c. 40 uL of SAM solution is added to dry chip for 20 seconds of SAM formation time.
d. Chips were then washed as follows:
Nanopure water (4 times)
Testing buffer (2 times)
e. Chips were then plugged into the CHI 650C system

Reference and counter electrodes were added to the EC system.

Experimental results: Total current peak ratio

| Amp Time | 2.7% | 6.2% | 9.8% |
|---|---|---|---|
| 45 seconds | 0.628 | 0.405 | 0.574 |
| 60 seconds | 0.707 | 0.473 | 0.834 |
| 90 seconds | 0.843 | 0.596 | 1.014 |

This example was performed using a setup as depicted in FIG. 6, which shows an experimental set-up for an assay utilizing a filter membrane embedded in a standard microplate as a solid support. The filter membrane can be modified with binding ligands or impregnated with beads modified with binding ligands to provide target-specific capture within the membrane, while allowing simplified washing, removal of excess or unbound assay components, and assay solution flow-through.

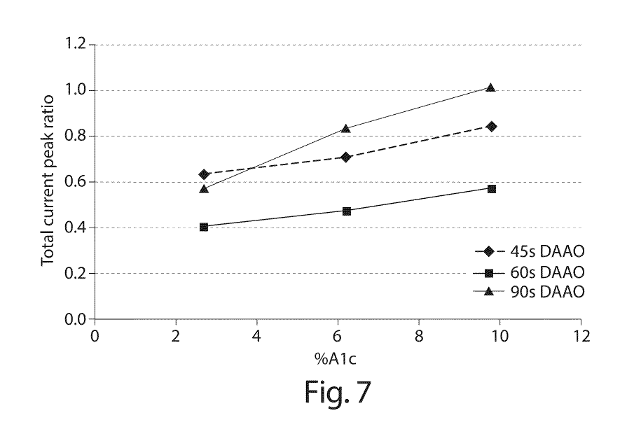

A successful dose response was obtained at each amplification time tested. These results are summarized in graphical form in FIG. 7. FIG. 7 shows the results of a dose response for a hemoglobin A1c assay. The signal detected by the electrode increases as the percentage of A1c increases. Performed using A1c calibrants with the setup shown in FIG. 6, and detailed in Example 1.

### Example 2

Multiplexing assay will make use of fluid retaining membranes to hold and isolate sample and reaction solutions added to entire chip. Membranes will be pre-loaded with enzymes/antibodies specific to the analytes of interest, but separated by membrane so as to detect a single analyte per electrode (see FIG. 2). In this way a sample solution containing mixed analytes can be added to an array of electrodes, then removed after each absorbent membrane has taken in sample so solution is isolated within the membranes but the spaces between them are dry. Assay can then be carried out to obtain signal without cross reactivity between electrodes.

Target Preparation

An enzyme mix is prepared, containing MbCl2, phyophocreatine, glycerol, creatine kinase, glycerol kinase, FAD, EtOH, AHD, Anti-HSP70, and SA-AP, containing all necessary components of an enzymatic amplification system to generate peroxide (besides those within membranes) if a target is present within a sample. The buffer containing TBS and Maltoside was added to bring the total volume to 2.5 mL
1. Four different samples (samples A-D) were prepared with varying concentrations of three different targets (ATP, NADH, and HSP70). Concentrations of each target within each sample are shown in Table 2A below.
2. Each target analyte is prepared individually then combined as such to make the 4 samples (samples A-D) shown in Table 2B.

TABLE 2A
Target Concentrations in Each Sample

| | Sample A | Sample B | Sample C | Sample D |
|---|---|---|---|---|
| ATP (uM) | 500 | 25 | 1 | 0 |
| NA DH (uM) | 0 | 500 | 25 | 1 |
| HSP 70 (gn/mL) | 1 | 0 | 100 | 10 |

3. The final mixed samples are combined 1:1 with 2× enzyme mix prior to beginning assay.

Electrode Preparation
1. SAMs of EAMs were prepared the night before to create an array of electrodes on 6-well chips (max of 6 electrode positions within the array). Four identical chips were prepared, one for each sample.
2. Membranes are cut to match the size of the individual electrodes in the array.
3. Membranes are soaked with different target-detecting solutions
a. For ATP: Glycerol-3-phosphate Oxidase (G3PO)—0.75 units per membrane at 1.5 U/mL
b. For NADH: NADH Oxidase (NAOX)—1.72 ug per membrane at 0.344 ug/uL
c. For HSP70: anti-HSP70 loaded magnetic beads—50 ug magnetic beads per membrane
4. Membranes are dried under vacuum for approximately 10 min.
5. Membranes are placed on top of electrodes (as shown in FIG. 2). An Untreated membrane electrode is included as a control (membrane does not contain any target-specific components). Electrode placement within the array is as follows (positions 1 and 2 unused)
a. ATP: Electrode position 3
b. NADH: Electrode position 4
c. Untreated: Electrode position 5
d. HSP70: Electrode position 6

Assay
1. One sample is added to each chip (i.e., the first chip gets sample A, the second chip gets sample B, etc.). A total of 20 uL is added
a. For this assay, 15 uL of sample-enzyme mix solution is added directly to the electrode, then the appropriate membranes are placed on top of each electrode, and an additional 5 uL sample-enzyme mix solution is added on top of membranes. Sample is allowed to soak into/be drawn up into membranes. As noted above, any excess sample not absorbed by membranes is removed.
2. Membranes and reagents are allowed to incubate as follows:
a. For ATP, NADH, and untreated membranes, total incubation time of 2 hours. No additional steps required.
b. For HSP70, initial incubation time of 90 min
i. After 90 min, HSP70 membranes are then remove and washed with buffer containing HEPES and Maltoside by placing membranes over absorbent layer to pull wash buffer through membrane. After wash, membranes are rinsed with TBS and returned to original electrode position in each array.
ii. Amplification solution with FADP, DAAO, D-Proline in TBS are added to HSP70 membranes, 15 uL per membrane. Again, as noted above, any excess is removed so solution remains isolated within membrane and area between membranes remains dry.
iii. Amplification solution is allowed to incubate on electrode for 10 min. (After this time the ATP and NADH reactions are complete.)
3. All membranes are removed from electrodes
4. Electrodes are washed with nanopure water, then tested in LiClO4. Onboard counter and reference electrodes are used during measurement.

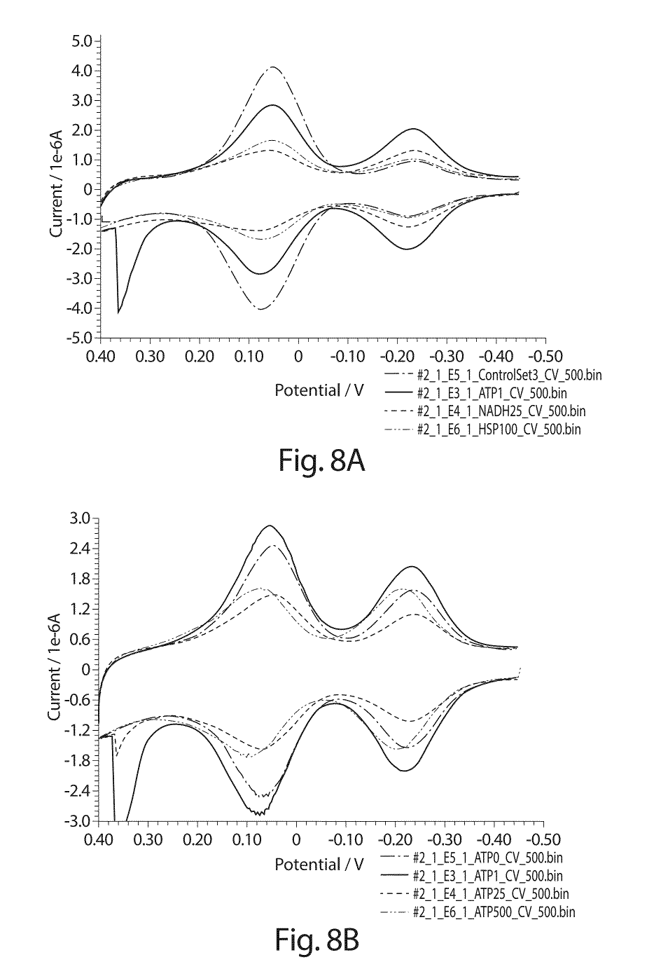

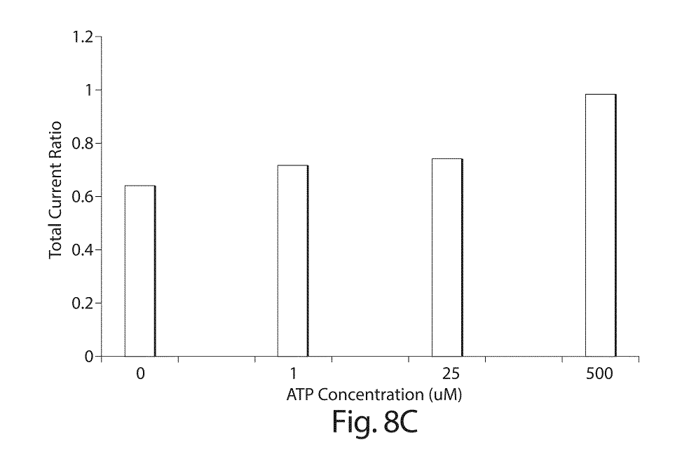

FIG. 8A shows an example of data collected through the array of electrodes. Each target analyte (ATP, NADH, HSP70, and control) within the sample generates an individual signal within the array of electrodes. Performed using Sample C detailed in Example 2. FIG. 8B shows an example of data collected through the array of electrodes for one of the target analytes present within all multiplex samples. FIG. 8C shows a graphical representation of a dose response generated for one of the target analytes present within multiplex samples. In both FIG. 8B and FIG. 8C, signal generated at varying concentrations of ATP is shown, measured across all samples (samples A-D) in Example 2.

### Example 3

The multiplexing assay described in Example 2 above is repeated for a new set of target analytes (Glucose, Cholesterol, HbA1c).

Target Preparation
1. Four different samples (samples A-D) were prepared with varying concentrations of three different targets (glucose, cholesterol, and HbA1c). Concentrations of each target within each sample are shown in Table 3A below. Each target analyte is prepared individually then combined as such to make the 4 samples.

TABLE 3A
Target Concentrations in Each Sample

| | Sample A | Sample B | Sample C | Sample D |
|---|---|---|---|---|
| Glucose (mM) | 1 | 0.2 | 0 | 5 |
| Cholesterol (mM) | 0.2 | 0 | 5 | 1 |
| HbA1c (%) | 10 | 5 | 2.5 | 0 |
| | (Bio-Rad | (Bio-Rad | (Bio-Rad | (BSA) |
| | Calibrant 3) | Calibrant 2) | Calibrant 1) | |

2. The final samples are combined with secondary antibody for HbA1c prior to beginning assay.

Electrode Preparation
1. SAMs of EAMs were prepared the night before to create an array of electrodes on 6-well chips (max of 6 electrode positions within the array). Four identical chips were prepared, one for each sample.
2. Membranes are cut to match the size of the individual electrodes in the array.
3. Membranes are soaked with different target-detecting solutions
a. For Glucose: Magnetic beads loaded with Glucose Oxidase (GOX)
b. For Cholesterol: Magnetic beads loaded with Cholesterol Oxidase (CholOX)
c. For HbA1c: Magnetic beads loaded with anti-hemoglobin capture antibody
4. Membranes are dried under vacuum for approximately 10 min.
5. Membranes are placed on top of electrodes (as shown in FIG. 2). An Untreated membrane electrode is included as a control (membrane does not contain any target-specific components). Electrode placement within the array is as follows (positions 1 and 2 unused)
a. Glucose: Electrode position 3
b. Cholesterol: Electrode position 4
c. HbA1c: Electrode position 5
d. Untreated: Electrode position 6

Assay

As in Example 2 above. Note: Glucose and cholesterol reactions will produce peroxide without additional components, HbA1c requires additional amplification solution to be added after initial incubation and washing.

Electrodes are washed with nanopure water, then tested in LiClO4. Onboard counter and reference electrodes are used during measurement.

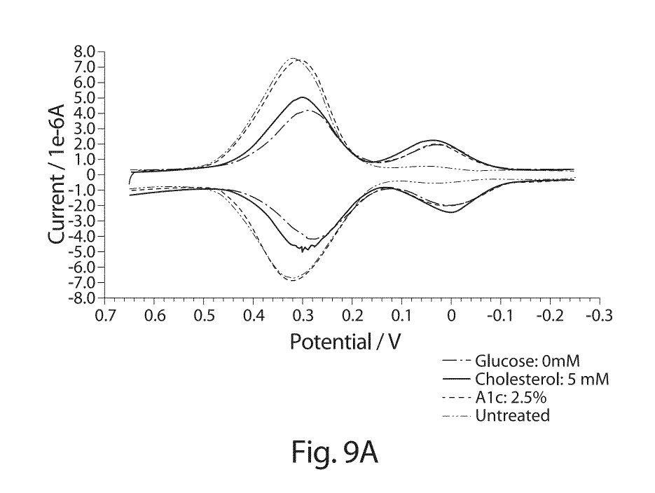

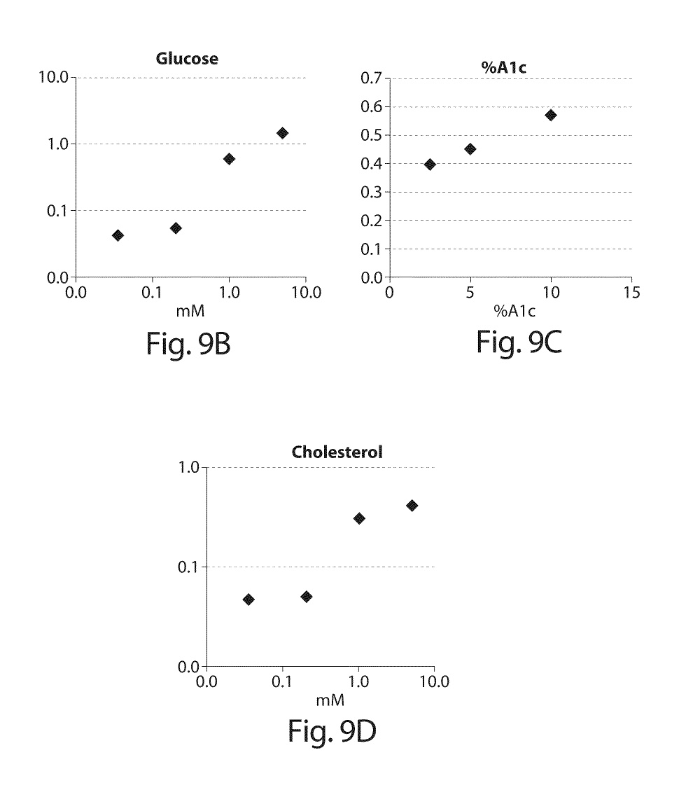

See FIG. 9A for an example of data collected through the array of electrodes for Sample C. Results are given in Table 3B below.

TABLE 3B
Results

| | | | Signal | | Signal | Choles- | Signal |
|---|---|---|---|---|---|---|---|
| | | | (Peak | Glucose | (Peak | terol | (Peak |
| Chip | Sample | A1c % | ratio) | (mM) | ratio) | (mM) | ratio) |
| 1 | A | 10 | 0.573 | 1 | 0.611 | 0.2 | 0.051 |
| 2 | B | 5 | 0.453 | 0.2 | 0.056 | 0 | 0.048 |
| 3 | C | 2.5 | 0.399 | 0 | 0.043 | 5 | 0.430 |
| 4 | D | 0 | none | 5 | 1.485 | 1 | 0.315 |

FIG. 9A. shows an example of the signal output (voltammograms, current as a function of potential) from an array of electrodes for 3 different targets: glucose, cholesterol, and hemoglobin A1c (A1c), as well as an untreated electrode (Sample C). FIG. 9B shows a dose response produced for A1c, FIG. 9C shows a dose response produced for glucose, and FIG. 9D shows a dose response produced for cholesterol. Assay set up shown in FIG. 2, and detailed in Example 3.

1. A method for detecting one or more target analytes within a test sample, comprising:
(A) adding a sample to a compartment comprising a porous substrate, wherein the porous substrate comprises an immobilized target specific detection molecule and is in contact with a solid support comprising an electrode comprising an electroactive moiety (EAM) comprising a transition metal complex and a self-immolative moiety (SIM), wherein the EAM has a first E⁰ when the SIM is present, and a second E⁰ when the SIM is absent;
exposing the porous substrates to a set of conditions that generate a mediator in the presence of a target analyte, wherein the mediator interacts with the EAM and the SIM is removed, such that the EAM has a second E⁰; and
measuring the change in E⁰ of solid support as an indicator of the presence of the target analyte within the sample; or
(B) adding a sample to a compartment comprising a first porous substrate and a second porous substrate in fluid communication, wherein:
the first porous substrate comprises an immobilized target specific detection molecule and the second porous substrate comprise a different immobilized target specific detection molecule,
the first porous substrate is in contact with a first solid support and the second porous substrates is in contact with a second solid support, and
the first solid support and the second solid support comprise an electrode comprising an electroactive moiety (EAM) comprising a transition metal complex and a self-immolative moiety (SIM), wherein the EAM has a first E⁰ when the SIM is present, and a second E⁰ when the SIM is absent and wherein the mediator interacts with the EAM and the SIM is removed, such that the EAM has a second E⁰;
exposing the first porous substrate and the second porous substrate to a set of conditions that results in the generation of a mediator in the first solid support in the presence of a first target analyte; and
measuring the change in E⁰ of the first solid support and the second solid support as an indicator of the presence of the first target analyte and the second target analyte within the sample.

2. (canceled)

3. The method according to claim 1, wherein when removing at least a portion of the sample from the compartment, an amount is removed such that liquid contact between said first and second porous substrates is eliminated.

4. The method according to claim 1, comprising exposing the first porous substrate and the second porous substrate to a set of conditions that results in the generation of a mediator in the second solid support in the presence of a second target analyte.

5. The method according to claim 4, wherein the mediator is a peroxide.

6. The method according to claim 1, wherein the EAM comprises a peroxide sensitive moiety (PSM).

7. The method according to claim 6, wherein the peroxide reacts with the PSM of the EAM and the SIM is removed, such that the EAM has a second E⁰.

8. The method according to claim 6, wherein the EAM has a first E⁰ when the SIM and PSM are present, and a second E⁰ when the SIM and PSM are absent;

9. The method according to claim 1, wherein the porous substrate and solid support are in direct contact.

10. The method according to claim 1, wherein the first porous substrate is in direct contact with a first solid support and the second porous substrates is in direct contact with a second solid support.

11. The method according to claim 1, wherein the porous substrate comprises particles.

12-17. (canceled)

18. The method according to claim 1, further comprising exposing the porous substrate to a soluble binding ligand comprising a label comprising a peroxide generating moiety or a component of a peroxide generating system, and optionally removing any excess solution, such that secondary binding ligands are isolated within the porous substrate.

19. (canceled)

20. A method for detecting a target analyte in a test sample, the method comprising:
providing a solid support comprising an electrode comprising:
a self-assembled monolayer (SAM);
a covalently attached electroactive active moiety (EAM) comprising a transition metal complex comprising a self-immolative moiety (SIM) and a peroxide sensitive moiety (PSM), wherein the EAM has a first E⁰ with the SIM attached and a second E⁰ with the SIM removed, and
a porous substrate comprising a capture binding ligand that binds the analyte;
contacting the target analyte(s) and the solid supports under conditions
wherein the target analyte binds the capture binding ligand to form a first complex;
contacting the first complex with a soluble capture ligand that binds the target analyte,
wherein the soluble capture ligand comprises a peroxide generating moiety to form a second complex;
adding substrate(s) of peroxide generating moiety to the second complex under conditions that peroxide is generated, where the peroxide reacts with the peroxide sensitive moiety of the EAM and the self-immolative moiety is removed such that the EAM has a second E⁰; and
detecting a change in E⁰ as an indication of the presence of the target analyte.

21-31. (canceled)

32. A composition comprising:
a first porous substrate comprising an immobilized target specific detection molecule;
a second porous substrate comprise a different immobilized target specific detection molecule, wherein the first porous substrate can be in fluid communication with the second porous substrate if solution is added
a first solid support in direct contact with the first porous substrate; and
a second solid support in direct contact with the second porous substrate, wherein the first solid support and the second solid support comprise an electrode comprising an electroactive moiety (EAM) comprising a transition metal complex, a self-immolative moiety (SIM), and a peroxide sensitive moiety (PSM), wherein the EAM has a first E⁰ when the SIM and PSM are present, and a second E⁰ when the SIM and PSM are absent.

33. An assay cartridge comprising,
a top layer comprising at least one chamber comprising an assay reagent;
a middle layer comprising a porous substrate comprising an immobilized target specific detection molecule; and
a bottom layer comprising a waste chamber and an electrode chamber, wherein the top, middle, and bottom layers have a common central axis and are capable of rotating around the common central axis.

34. An assay cartridge according to claim 33, wherein the electrode chamber comprises an electroactive moiety (EAM) comprising a transition metal complex and a self-immolative moiety (SIM), wherein the EAM has a first E⁰ when the SIM is present, and a second E⁰ when the SIM is absent.

35-37. (canceled)

38. An assay cartridge according to claim 33, wherein the connections between one or more layers are either exposed or sealed as one layer is rotated relative to an adjacent layer.

39. An assay cartridge according to claim 33, wherein the top layer comprises one or more liquid or dry assay components.

40. An assay cartridge according to claim 39, wherein the assay components are selected from the group consisting of tagged binding ligands, signal generating reagents, pH adjusting reagents, washing solutions, detection reagents, and testing reagents.

41. (canceled)

42. A method for detecting hemoglobin A1c, comprising:
adding a sample to the assay cartridge of claim 33; and
qualitatively determining, from the change in E⁰ at the electrode chamber, if the fraction of hemoglobin that is hemoglobin A1c is above a defined threshold.

43-44. (canceled)
